(19) United States
(12) Patent Application Publication
(10) Pub. No.: US 2026/0185381 A1
(43) Pub. Date: Jul. 2, 2026

(54) DISH WASHER

(71) Applicant: LG Electronics Inc., Seoul (KR)

(72) Inventors: Jaehyun RA, Seoul (KR); Sang Woo WOO, Seoul (KR); Jin Woo SHIM, Seoul (KR); Jayhee PARK, Seoul (KR); Seunghoon LEE, Seoul (KR)

(21) Appl. No.: 19/416,397

(22) Filed: Dec. 11, 2025

(30) Foreign Application Priority Data
Dec. 30, 2024 (KR) 10-2024-0199778
May 22, 2025 (KR) 10-2025-0066594

(51) Int. Cl. E05B 5/02; A47L 15/42; E05B 5/00

(52) U.S. Cl. CPC E05B 5/003; A47L 15/4257; E05B 5/006

(57) ABSTRACT

A dish washer includes a blind module capable of covering an opening of a door that is opened as a pop-up handle moves to an extended position, thereby preventing an inner space of the door from being contaminated by foreign substances that may be introduced through the opening of the door, preventing a malfunction and a damage to a driver resulted from the introduction of the foreign substances, and preventing aesthetic sensibility perceived by a user from being deteriorated by blocking observation of the inner space of the door.

### CROSS-REFERENCE TO RELATED APPLICATION

This application claims priority to and benefit of Korean Patent Application No. 10-2024-0199778, filed on Dec. 30, 2024, and Korean Patent Application No. 10-2025-0066594, filed on May 22, 2025, which are hereby incorporated by reference as when fully set forth herein.

### BACKGROUND

### Field

The present disclosure relates to a dish washer and a home appliance, and more specifically, to a dish washer including a blind module capable of covering an opening of a door that is opened as a pop-up handle moves to an extended position, thereby preventing an inner space of the door from being contaminated by foreign substances that may be introduced through the opening of the door, preventing a malfunction and a damage to a driver resulted from the introduction of the foreign substances, and preventing aesthetic sensibility perceived by a user from being deteriorated by blocking observation of the inner space of the door.

### Description of Related Art

A dish washer is an apparatus that washes dishes and cooking utensils as washing targets stored therein by spraying washing water thereto. In this regard, the washing water may contain washing detergent.

A dish washer generally includes a washing tub having a washing space defined therein, a dish rack that accommodates therein a washing target inside the washing tub, a spraying arm that sprays the washing water into the dish rack, and a sump that stores therein water and supplies the washing water to the spraying arm.

Using this dish washer may allow a time and effort required to wash the dishes and other washing targets after a meal to be reduced, thereby contributing to user convenience.

Generally, the dish washer is configured to perform a washing cycle for washing a washing target, a rinsing cycle for rinsing a washing target, and a drying cycle for drying a washing target that has been washed and rinsed.

In order to store dishes inside the dish washer before the cycle proceeds, and to withdraw the washed and dried dishes after the cycle has been completed, the user should open and close the door.

In this regard, it is common that the door is provided with a handle that the user may grip as a means for facilitating the opening and closing of the door.

In this regard, European Patent No. 2096360 (Prior Document 001) discloses a dish washer configured such that a pop-up handle protruding from a front surface of the door during gripping for opening and closing the door is provided in the door.

### Prior Art Documents

### Patent Documents

(Patent document 001) European Patent No. 2096360

### SUMMARY

The handle disclosed in Prior Document 001 described above is constructed to manually protrude from a non-use position at which an amount of protrusion thereof from the door is minimized toward a use position at which it may be gripped by the user while rotating.

Accordingly, the handle disclosed in Prior Document 001 requires a manipulation of the user of manually moving the same from the non-use position to the use position and a manipulation of the user of manually moving the same from the use position to the non-use position again when the opening and closing of the door is completed, and thus inconvenience of the user may be caused.

Further, the handle disclosed in Prior Document 001 remains protruded and fixed at the use position once it protrudes to the use position, unless the user performs the manipulation of moving the same back to the non-use position.

Accordingly, the handle disclosed in Prior Document 001 has a problem in that the advantage as the pop-up handle is halved because the handle is maintained in the state that is substantially no different from that of a handle protruding at all times.

Further, when the handle disclosed in Prior Document 001 protrudes to the use position, an inner space of the door, which was hidden when the handle was positioned at the non-use position, may be at least partially exposed to the outside.

Accordingly, the handle disclosed in Prior Document 001 has a structure in which the external foreign substances such as dust may be introduced and accumulated through a portion of the handle exposed to the outside as the handle moves to the use position, and thus a sanitary problem may be caused.

Further, when the handle disclosed in Prior Document 001 moves to the use position, the opening having a considerably great cross-sectional area corresponding to a size of the handle may be exposed to the outside, so that an external object having a considerably great volume may be introduced into the door, and thus, there is a very high possibility of damage to components disposed inside the door.

Further, when the handle disclosed in Prior Document 001 moves to the use position, the opening having the considerably great cross-sectional area corresponding to the size of the handle may be exposed to the outside, allowing the user to observe the inner space of the door, which may act as a factor that detracts from aesthetic appearance perceived by the user.

The present disclosure has been devised to solve such problems of the prior art, and a first purpose of the present disclosure is to provide a dish washer in which a handle is constructed to automatically protrude and move frontwards from a door only when necessary such as opening and closing of the door to prevent external foreign substances such as dust or the like from being introduced into the door, thereby preventing an inner space of the door from being contaminated and greatly improving user convenience.

In addition, a second purpose of the present disclosure is to provide a dish washer in which a blind module capable of covering an opening of a door, which is opened as a pop-up handle is moved to an extended position, is included, thereby preventing an inner space of the door from being contaminated by foreign substances that may be introduced through the opening of the door, preventing a malfunction of a driver and damage to the driver resulted from the introduction of the foreign substances, and preventing an aesthetic sensibility perceived by a user from being deteriorated by blocking observation of the inner space of the door.

In addition, a third purpose of the present disclosure is to provide a dish washer in which a front end surface of a blind module for covering an opening of a door is formed to have a sense of unity with a front surface of the door, thereby further improving an aesthetic sensitivity sensed by a user.

In addition, a fourth purpose of the present disclosure is to provide a dish washer in which a handle driver that moves a door between a retracted position and an extended position is configured to include a single driving motor, thereby reducing a space occupied by the handle driver and improving a space utilization of an inner space of the door.

In addition, a fifth purpose of the present disclosure is to provide a dish washer in which a handle driver is configured to include a positional deviation adjustor for adjusting a deviation in an amount of movement between both ends of a handle, which may occur when the handle driver drives the handle using a single driving motor, thereby preventing a damage to the handle and an increase in a load of a driving motor resulted from occurrence of a positional deviation.

Purposes of the present disclosure are not limited to the above-mentioned purposes, and other purposes and advantages of the present disclosure that are not mentioned may be understood by the following description, and will be more clearly understood by embodiments of the present disclosure. In addition, it will be readily seen that purposes and advantages of the present disclosure may be realized by means indicated in the claims and combinations thereof.

An aspect of the present disclosure provides a dish washer comprising: a tub defining therein a washing space having an open front surface; a door configured to open and close the open front surface of the tub; a handle configured to horizontally move back and forth between an extended position where the handle protrudes frontwards from the door and a retracted position where the handle is at least partially accommodated in the door; a handle driver disposed inside the door and configured to horizontally move the handle from the retracted position toward the extended position or from the extended position toward the retracted position; and a blind module configured to cover an opening defined through the door to allow the handle to pass therethrough when the handle has moved to the extended position, wherein the blind module is configured to cover the opening while moving frontwards in association with the movement of the handle.

In accordance with some embodiments of the dish washer, the blind module includes: a blind panel configured to cover the opening while horizontally moving between a most rearward position and a most forward position in association with the movement of the handle; a bracket positioned at the rear of the blind panel; and a spring disposed between the bracket and the blind panel, wherein the spring is configured to exert a restoring force on the blind panel in a direction where the blind panel becomes away from the bracket.

In accordance with some embodiments of the dish washer, the handle includes: a first handle body extending along a left-right direction from one end to a remaining end thereof; and a second handle body and a third handle body respectively coupled to the one end and the remaining end of the first handle body and extending rearwards from the first handle body, wherein when the handle has moved to the retracted position, the opening is entirely closed by the first handle body, the second handle body, and the third handle body, and the blind panel is pressed by the first handle body and horizontally moves to the most rearward position.

In accordance with some embodiments of the dish washer, when the above blind panel has horizontally moved to the most rearward position, the spring is in a state of being maximally compressed.

In accordance with some embodiments of the dish washer, when the blind panel has horizontally moved to the most rearward position, the blind panel remains in close contact with the first handle body.

In accordance with some embodiments of the dish washer, when the handle starts to move from the retracted position toward the extended position, the blind panel horizontally moves frontwards together with the first handle body from the most rearward position because of the restoring force of the spring.

In accordance with some embodiments of the dish washer, when the first handle body passes through the opening and protrudes entirely outwards from the door after the handle starts to move from the retracted position toward the extended position, the opening is partially opened, and the blind panel horizontally moves to the most forward position by the restoring force of the spring, thereby closing the partially opened opening.

In accordance with some embodiments of the dish washer, when the blind panel has horizontally moved to the most forward position, the spring is in a state of being minimally compressed.

In accordance with some embodiments of the dish washer, when the blind panel has horizontally moved to the most forward position, the blind panel is separated from the first handle body.

In accordance with some embodiments of the dish washer, when the blind panel has moved to the most forward position, a front end surface of the blind panel stops while forming a continuous surface with a front surface of the door.

In accordance with some embodiments of the dish washer, when the blind panel has moved to the most forward position, a front end surface of the blind panel stops at a position protruding from a front surface of the door.

In accordance with some embodiments of the dish washer, the blind panel is connected to the bracket such that a spacing in a front-rear direction therebetween is variable.

In accordance with some embodiments of the dish washer, the blind panel includes a first protrusion formed to protrude toward the bracket, wherein the bracket includes a second protrusion formed to protrude toward the blind panel, wherein the first protrusion and the second protrusion are connected to each other in a telescopic manner.

In accordance with some embodiments of the dish washer, the dish washer further comprises a handle frame disposed inside the door and supporting the handle so as to be horizontally moveable.

In accordance with some embodiments of the dish washer, an inner surface of the handle frame is integrally formed with multiple reinforcing rib extending linearly along a front-rear direction, wherein the back and forth horizontal movement of the blind panel is guided by the reinforcing ribs.

In accordance with some embodiments of the dish washer, the blind panel includes: a panel body covering the opening; and a flange formed to protrude along a vertical direction from an upper end surface or a lower end surface of the panel body, wherein the flange has multiple slit, wherein the multiple reinforcing rib are inserted into the multiple slit.

Another aspect of the present disclosure provides a home appliance comprising: a tub defining therein a washing space having an open front surface; a door configured to open and close the inner surface defined inside the tub; a handle configured to horizontally move back and forth between an extended position where the handle protrudes frontwards from the door and a retracted position where the handle is at least partially accommodated in the door; a handle driver disposed inside the door and configured to horizontally move the handle from the retracted position toward the extended position or from the extended position toward the retracted position; and a blind module configured to cover an opening defined through the door to allow the handle to pass therethrough when the handle has moved to the extended position, wherein the blind module is configured to cover the opening while moving frontwards in association with the movement of the handle.

The dish washer according to the present disclosure may construct the handle to automatically protrude and move frontwards from the door only when necessary such as the opening and closing of the door, to prevent the external foreign substances such as dust or the like from being introduced into the door, thereby preventing the inner space of the door from being contaminated and greatly improving the user convenience.

Further, the dish washer according to the present disclosure may configure the handle driver for moving the door between the retracted position and the extended position to include the single driving motor, thereby reducing the space occupied by the handle driver and improving the space utilization for the inner space of the door.

Further, the dish washer according to the present disclosure may include the positional deviation adjustor for adjusting the deviation in the amount of movement between both ends of the handle, which may occur when the handle driver drives the handle using the single driving motor, thereby preventing the damage to the handle and the increase in the load of the driving motor resulted from the occurrence of the positional deviation.

Further, the dish washer according to the present disclosure may include the blind module capable of covering the opening of the door, which is opened as the pop-up handle is moved to the extended position, thereby preventing the inner space of the door from being contaminated by the foreign substances that may be introduced through the opening of the door.

Further, the dish washer according to the present disclosure may include the blind module capable of covering the opening of the door, which is opened as the pop-up handle is moved to the extended position, thereby preventing the malfunction of the driver and the damage to the driver resulted from the introduction of the foreign substances.

Further, the dish according to the present disclosure may include the blind module capable of covering the opening of the door, which is opened as the pop-up handle is moved to the extended position, thereby preventing the aesthetic sensibility perceived by the user from being deteriorated by blocking the observation of the inner space of the door.

Further, the dish washer according to the present disclosure may form the front end surface of the blind module for covering the opening of the door to have the sense of unity with the front surface of the door, thereby further improving the aesthetic sensitivity sensed by the user.

In addition to the above-described effects, specific effects of the present disclosure will be described together while describing specific matters for implementing the present disclosure.

### BRIEF DESCRIPTION OF DRAWINGS

FIG. 1 is a front perspective view of a dish washer according to one embodiment of the present disclosure.

FIG. 2 is a schematic cross-sectional view of the dish washer as shown in FIG. 1.

FIG. 3 is a front perspective view showing a state in which a pop-up handle of a dish washer according to an embodiment of the present disclosure has been moved to a retracted position.

FIG. 4 is a front perspective view showing a state in which the pop-up handle as shown in FIG. 3 has been moved to an extended position.

FIG. 5A is a side enlarged side view of FIG. 3.

FIG. 5B is an exploded perspective view of a handle shown in FIG. 3.

FIG. 6 is a rear perspective view of a door shown in FIG. 3, illustrating a state in which a rear panel of the door is removed.

FIG. 7 is a rear perspective view of a handle driver and a handle frame shown in FIG. 6.

FIG. 8 is an exploded perspective view of a handle driver, a blind module, and a handle shown in FIG. 7.

FIG. 9 is a front perspective view of a blind module shown in FIG. 8.

FIG. 10 is a rear partial-enlarged view of a handle frame shown in FIG. 7.

FIG. 11 is a partially enlarged view of a handle driver shown in FIG. 7.

FIGS. 12 and 13 are plan views for describing a process in which a handle is moved from a retracted position to an extended position by a handle driver shown in FIG. 10 and a process in which a blind panel of a blind module is moved frontwards in association with the movement of the handle.

FIGS. 14A and 14B are cross-sectional views for illustrating a relative position of a blind panel in a state in which a handle has been moved to a retracted position.

FIG. 14C is a view showing a state in which a blind panel is stopped at a most forward position while a handle is moving to an extended position, and FIG. 14D is a view showing a state in which a blind panel is stopped at the most forward position as the handle has moved to the extended position.

FIG. 14E is a partial enlarged view of FIG. 14C.

FIGS. 14F to 14H are cross-sectional views for illustrating other embodiments regarding a shape and a position of a front end surface of a blind panel.

FIGS. 15 to 17 are partially enlarged views for illustrating a process in which a positional deviation that occurs between a left end and a right end of a handle is adjusted by a positional deviation adjustor shown in FIG. 9.

### DETAILED DESCRIPTION

The above-mentioned purpose, features and advantages are described in detail below with reference to the attached drawings. Accordingly, a person skilled in the art in the technical field to which the present disclosure belongs will be able to easily implement the technical idea of the present disclosure. In describing the present disclosure, when it is determined that a detailed description of the known technology related to the present disclosure may unnecessarily obscure the gist of the present disclosure, the detailed description thereof is omitted. Hereinafter, preferred embodiments according to the present disclosure will be described in detail with reference to the attached drawings. In the drawings, identical reference numerals are used to indicate identical or similar components.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described later could be termed a second element, component, region, layer or section, without departing from the spirit and scope of the present disclosure.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise.

It will also be understood that when a first element or layer is referred to as being present “on” a second element or layer, the first element may be disposed directly on the second element or may be disposed indirectly on the second element with a third element or layer being disposed between the first and second elements or layers. It will also be understood that when a first element or layer is referred to as being present “under” a second element or layer, the first element may be disposed directly under the second element or may be disposed indirectly under the second element with a third element or layer being disposed between the first and second elements or layers.

It will be understood that when an element or layer is referred to as being “connected to”, or “coupled to” another element or layer, it may be directly connected to or coupled to another element or layer, or one or more intervening elements or layers therebetween may be present. In addition, it will also be understood that when an element or layer is referred to as being “between” two elements or layers, it may be the only element or layer between the two elements or layers, or one or more intervening elements or layers therebetween may also be present.

It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements may modify the entire list of elements and may not modify the individual elements of the list. In interpretation of numerical values, an error or tolerance therein may occur even when there is no explicit description thereof.

Spatially relative terms, such as “beneath,” “below,” “lower,” “under,” “above,” “upper,” and the like, may be used herein for ease of explanation to describe one element or feature's relationship to another element or feature as illustrated in the figures. It will be understood that the spatially relative terms are intended to encompass different orientations of the device in use or in operation, in addition to the orientation depicted in the figures. For example, when the device in the drawings may be turned over, elements described as “below” or “beneath” or “under” other elements or features would then be oriented “above” the other elements or features. Thus, the example terms “below” and “under” may encompass both an orientation of above and below. The device may be otherwise oriented for example, rotated 90 degrees or at other orientations, and the spatially relative descriptors used herein should be interpreted accordingly.

As used herein, “A and/or B” means A, B or A and B, unless specifically stated otherwise. Expression such as “at least one of” when preceding a list of elements may modify the entirety of list of elements and may not modify the individual elements of the list. As used herein, “C to D” means C inclusive to D inclusive unless otherwise specified.

Hereinafter, the present disclosure will be described with reference to drawings showing a configuration according to an embodiment of the present disclosure.

### Overall Structure of Dish Washer

Hereinafter, an overall structure of a dish washer 1 according to an embodiment of the present disclosure will be described in detail with reference to the attached drawings.

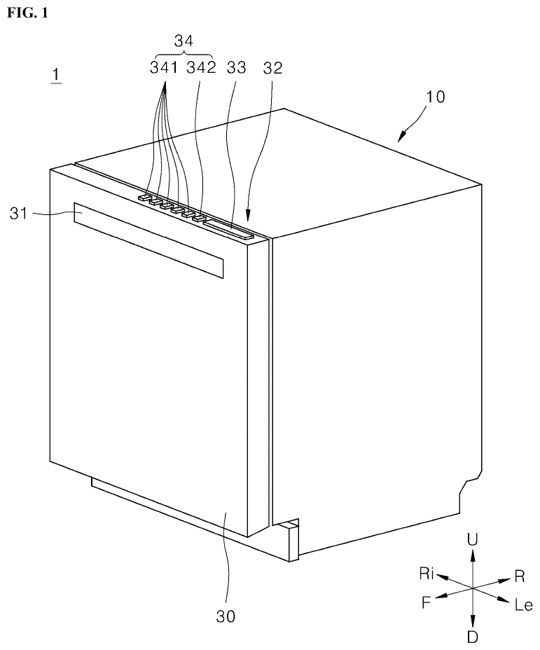

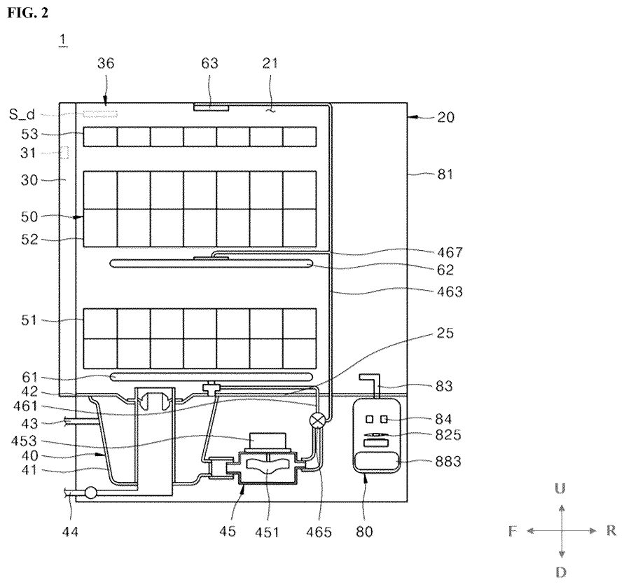

FIG. 1 is a front perspective view showing the dish washer 1 according to the present disclosure. FIG. 2 is a simplified cross-sectional view briefly showing an internal structure of the dish washer 1 according to the present disclosure.

As shown in FIG. 1 and FIG. 2, the dish washer 1 according to the present disclosure may include a casing 10 that constitutes an exterior appearance.

Further, the dish washer 1 according to the present disclosure may include a tub 20 installed inside the casing 10, defining therein a washing space 21 in which a washing target is washed, and having an open front surface.

Further, the dish washer 1 according to the present disclosure may include a door 30 that opens/closes the open front surface of the tub 20.

Further, the dish washer 1 according to the present disclosure may include a driver 40 located under the tub 20 to supply, collect, circulate, and discharge the washing water for washing the washing target.

Further, the dish washer 1 according to the present disclosure may include a dish rack 50 detachably disposed in the inner washing space 21 of the tub 20 and on which the washing target is seated.

Further, the dish washer 1 according to the present disclosure may include a water sprayer 60 installed adjacent to the dish rack 50 to spray the washing water for washing the washing target thereto.

In this regard, the washing target seated on the dish rack 50 may be, for example, dishes such as bowls, plates, spoons, and chopsticks, and other cooking utensils. Hereinafter, unless otherwise specified, the washing target will be referred to as a dish.

The tub 20 may be formed in a box shape with an entirely open front surface, and corresponds to a configuration known as a so-called washing tank.

The washing space 21 may be defined inside the tub 20. The open front surface of the tub 20 may be opened/closing by the door 30.

The tub 20 may be formed via pressing of a metal plate resistant to high temperature and moisture, for example, a stainless steel plate.

Moreover, on an inner surface of the tub 20, a plurality of brackets may be disposed for the purpose of supporting and installing functional components such as the dish rack 50 and the water sprayer 60 which will be described later thereon within the tub 20.

In one example, the driver 40 may include a sump 41 that stores therein washing water.

Further, the driver 40 may include a sump cover 42 that distinguishes the sump 41 from the tub 20.

Further, the driver 40 may include a water supply 43 that supplies washing water from an external source to the sump 41.

Further, the driver 40 may include a water discharger 44 that discharges the washing water of the sump 41 to an outside.

Further, the driver 40 may include a washing pump 45 and a supply flow path 46 for supplying the washing water of the sump 41 to the water sprayer.

The sump cover 42 may be disposed at a top of the sump 41 and may serve to distinguish the tub 20 and the sump 41 from each other.

Moreover, the sump cover 42 may have a plurality of collecting holes defined therein for collecting washing water sprayed into the washing space 21 through the water sprayer 60 into the sump 41.

That is, the washing water sprayed from the water sprayer toward the dish may fall down to a bottom of the washing space 21, and may be collected again through the sump cover 42 and into the sump 41.

The washing pump 45 may be disposed at one side of the sump 41 and may serve to pressurize the washing water and supply the pressurized washing water to the water sprayer 60.

One end of the washing pump 45 may be connected to the sump 41 and the other end thereof may be connected to the supply flow path 46. The washing pump 45 may include an impeller 451 and a motor 453. When power is supplied to the motor 453, the impeller 451 may rotate, and thus the washing water in the sump 41 may be pressurized, and then may be supplied to the water sprayer through the supply flow path 46.

Although not shown, the washing pump 45 may include a washing water heater for heating washing water supplied during a washing cycle or a heating rinsing cycle.

In one example, the supply flow path 46 may serve to selectively supply the washing water supplied from the washing pump 45 to the water sprayer 60.

For example, the supply flow path 46 may include a first supply flow path 461 connected to a lower spraying arm 61, and a second supply flow path 463 connected to an upper spraying arm 62 and a top nozzle 63.

The supply flow path 46 may be provided with a supply flow path switching valve 465 that selectively opens/closes the supply flow paths 461 and 463.

In this regard, the supply flow path switching valve 465 may be controlled so that the supply flow paths 461 and 463 are opened sequentially or simultaneously.

In one example, the water sprayer 60 may be constructed to spray the washing water to the dishes stored on the dish rack 50.

More specifically, the water sprayer 60 may include the lower spraying arm 61 located at a lower portion of the tub 20 to spray the washing water to a lower rack 51.

Further, the water sprayer 60 may include the upper spraying arm 62 located between the lower rack 51 and an upper rack 52 to spray the washing water to the lower rack 51 and the upper rack 52.

Further, the water sprayer 60 may include the top nozzle 63 located at an upper portion of the tub 20 to spray the washing water to a top rack 53 or the upper rack 52.

In particular, the lower spraying arm 61 and the upper spraying arm 62 may be rotatably disposed in the washing space 21 of the tub 20 and may spray the washing water toward the dish of the dish rack 50 while rotating.

The lower spraying arm 61 may be rotatably supported above the sump cover 42 so as to spray the washing water toward the lower rack 51 while rotating and being disposed under the lower rack 51.

Moreover, the upper spraying arm 62 may be rotatably supported by a spraying arm holder 467 so as to spray the washing water on the dish while rotating and being disposed between the lower rack 51 and the upper rack 52.

In one example, although not shown, in order to increase washing efficiency, additional means for diverting the washing water sprayed from the lower spraying arm 61 into an upward direction (diverting in a U-direction) may be provided at a lower surface 25 of the tub 20.

A detailed configuration of the water sprayer 60 has been already known in the art. Thus, a description of the specific configuration of the water sprayer 60 will be omitted below.

The dish rack 50 for storing the dish therein may be disposed in the washing space 21.

The dish rack 50 may be constructed to extend or retract from or into the inner space of the tub 20 through the open front surface of the tub 20.

For example, in FIG. 2, an embodiment is shown in which the dish rack includes the lower rack 51 located at the lower portion of the tub 20 to accommodate thereon relatively large dishes, the upper rack 5 located on top of the lower rack 51 to accommodate thereon medium-sized dishes, and the top rack 53 located at a top level of the tub 20 and capable of storing thereon small dishes, etc. However, However, embodiments of present disclosure are not limited thereto. However, hereinafter, an example in which the dish washer 1 includes the three dish racks 50 as shown is described.

Each of the lower rack 51, the upper rack 52, and the top rack 53 may be constructed to extend to the outside through the open front surface of the tub 20.

To this end, guide rails (not shown) may be respectively disposed on both opposing inner side walls constituting an inner surface of the tub 20. By way of example, the guide rails may include an upper rail, a lower rail, and a top rail.

Wheels may be disposed on a bottom of each of the lower rack 51, the upper rack 52, and the top rack 53. The user may extend the lower rack 51, the upper rack 52, and the top rack 53 to the outside through the open front surface of the tub 20 and may place the dishes thereon, or easily withdraw the dishes that have been washed out thereof.

The guide rail (not shown) may be embodied as a simple rail-type fixed guide rail to guide the extending or the retracting of the rack 50, or a telescopic guide rail capable of guiding the extending or the retracting of the rack 50 and at the same time, increasing an extension distance thereof as the rack 50 further extends from the inner space of the tub.

In one example, the door 30 is configured for opening/closing the open front surface of the tub 20 as described above.

A hinge (not shown) around which the door 30 is closed or opened may be generally provided at a bottom of the open front surface. Thus, the door 30 may open by pivoting around the hinge as a pivot axis.

In this regard, a handle 31 for opening the door 30 and a control panel 32 for controlling an operation of the dish washer 1 may be disposed on an outer side surface of the door 30.

As shown, the control panel 32 may include a display 33 that visually displays information regarding a current operating status of the dish washer 1, etc., and a button unit 34 including a selection button through which a user's course selection manipulation is input and a power button through which a user's manipulation for turning the dish washer on and off is input.

In one example, a rear panel constituting an inner side surface of the door 30 may constitute one surface of the tub 20 when the door 30 has been closed, and may constitute a seat surface on which the lower rack 51 of the dish rack 50 is supported when the door 30 is fully opened.

To this end, when the door 30 is fully opened downwardly, the rear panel of the door 30 may constitute a horizontal plane extending in the same direction as a direction in which the guide rail guiding the movement of the lower rack 51 extends.

In one example, unlike a conventional handle, the handle 31 of the dish washer 1 according to the present disclosure may be configured to be at least partially accommodated in an inside of the door 30 when the handle is not in use, and to automatically extend in a protruding manner in a frontward direction from the door 30 when it is necessary to open and close the door 30.

In that the handle is configured to retract so as to be at least partially accommodated in the inside of the door 30 or extend in a protruding manner in a frontward direction from the door 30 out of the inside of the door 30, the handle 31 may be referred to as various names such as a pop-up handle, a retractable handle, an extendable handle, etc.

Hereinafter, the handle 31 configured to retract into or extend from the door 30 of the dish washer 1 according to one embodiment of the present disclosure will be referred to as the pop-up handle 31.

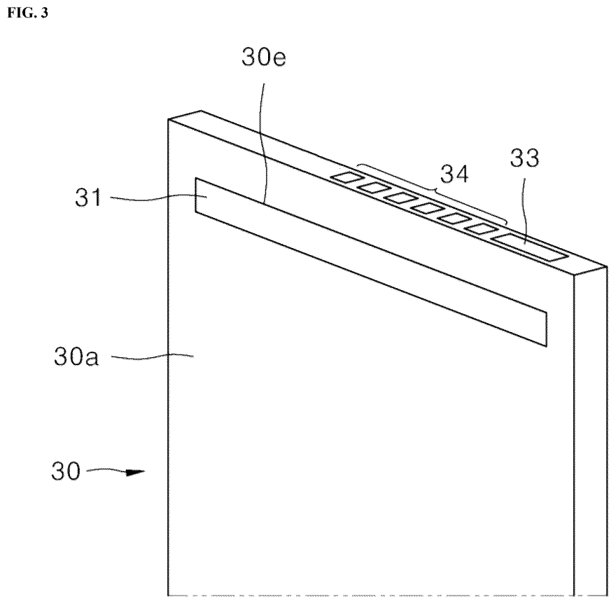

A detailed configuration of the pop-up handle 31 will be described later with reference to FIG. 3 and subsequent drawings.

Although not shown, the rear panel defining the inside of the door 30 may further be provided with a detergent supply device for automatically supplying detergent into the inside of the tub 20.

Furthermore, a door position sensor 36 may be disposed on an outer top surface of the tub 20 and may be configured to detect whether the door 30 is in a closed or open state. For example, the door position sensor 36 may include a door position sensor S_d or a latch sensor that detects a position of a door latch (not shown).

In one example, a drying air supply 80 may be disposed at the lower portion of the tub 20 and may be configured to generate and supply high-temperature or low-temperature drying air to the washing space 21 inside the tub 20.

As shown, the drying air supply 80 may be configured to include a filter member 883 for filtering outside air, a blower fan 825 for generating a drying air stream, a heater 84 for heating the drying air stream, and an air stream guide 83 disposed inside the tub 20 so as to guide the drying air stream.

A drying air supply hole may be defined in a lower surface of the tub 20 so that high-temperature drying air generated by the drying air supply 80 may be introduced into the inside of the tub 20 through the drying air supply hole.

Thus, the high-temperature drying air or low-temperature drying air may be supplied from the drying air supply 80 into the inside of the tub 20 during the drying cycle such that the drying efficiency and sterilization effect on the dishes may be significantly improved compared to a conventional dish washer.

In one example, the dish washer may be configured such that the air stream supplied to the inside of the tub 20 and moistened while drying the dishes may be discharged to the outside, and the discharge of the air stream may be accomplished via partial opening of the door 30 or via a separate air discharge means (not shown).

### Appearance and Operation Of Pop-Up Handle

Hereinafter, with reference to FIGS. 3 to 5B, the appearance and the operation of the pop-up handle 31 disposed at the door 30 of the dish washer 1 according to one embodiment of the present disclosure will be described in detail.

Hereinafter, a description will be made based on an embodiment in which the pop-up handle 31 and related components of the pop-up handle 31 are disposed inside the door 30 constituting the dish washer 1 as an example.

However, the present disclosure may not be limited thereto. Further, the pop-up handle 31 and the related components of the pop-up handle 31, which will be described later, may be similarly applied to home appliances such as an oven, a refrigerator, a dryer, a washing machine, or a laundry management apparatus constructed such that an inner space of a casing performing a specific function is opened and closed through a door.

However, such oven, refrigerator, dryer, washing machine, or laundry management apparatus are configured to operate under different operating conditions and operating environments with different purposes and functions from the dish washer 1 according to the present disclosure.

In particular, because the oven operates in a high-temperature environment, the pop-up handle and a handle driver should be made of a material that may withstand high temperatures. In addition, the door of the oven may secure a space in which the pop-up handle and the handle driver are to be installed, but because a glass material that is partially resistant to heat is used, the pop-up handle and the handle driver need to be harmonized with the glass material, and a means for ensuring durability and safety in the high-temperature environment may be further added.

In one example, in the refrigerator, a shelf, a storage space, an insulator, and the like are included inside the door, so that space utilization may be restricted.

Therefore, to install the pop-up handle and the handle driver, it may be necessary to redesign an internal structure of the door or secure a space that may be installed without interference to the existing structure. In addition, in case of the refrigerator, because the pop-up handle is located in the door that is frequently opened and closed, durability and waterproof design may be essential.

In consideration of this, a motor or an electronic component that drives the pop-up handle may be disposed in an empty space defined inside the door of the refrigerator, and needs to be designed to be compatible with a power supply structure of the refrigerator. However, a design may be required to prevent interference with the insulator and the shelf structure inside the door, and a means considering waterproofing and durability may be added.

In one example, the dryer is in an environment exposed to high temperature and moisture. The pop-up handle and the handle driver should be made of a material that may withstand the high temperatures, and a means for preventing damage from internal heat of the dryer needs to be added.

In one example, in case of the washing machine, a tub into which water, detergent, and laundry are put is disposed at the rear of the door. Therefore, when the pop-up handle and the handle driver are installed in the door of the washing machine, because there is a high possibility of exposure to water and detergent, waterproof and dustproof design may be essential. In particular, the handle driver should be installed in a sealed space such that an electric motor or an electronic component is not exposed to water, and a means for securing durability needs to be added via the waterproof and dustproof design.

In one example, because the laundry management apparatus includes a steam function, moisture may penetrate into the door. Therefore, the pop-up handle and the handle driver should be resistant to moisture and should be designed in a sealed structure such that water does not penetrate thereinto. Therefore, waterproof and moisture-proof means need to be added to ensure durability in the steam environment.

Considering such operating environments and operating conditions, because the washing machine, the styler, and the dryer are highly likely to be exposed to water and moisture, the sealed structure may be essential for the pop-up handle and the handle driver.

In addition, because the dryer and the oven need to operate in the high temperature environment, the pop-up handles and the handle drivers thereof should be made of the heat-resistant material.

In addition, the motor or the electronic component that drives the handle driver should be disposed by efficiently utilizing the inner space of the door, and may be designed so as not to cause inconvenience to the user. Furthermore, the pop-up handle and the handle driver need to be equipped with a means for user's safety and injury prevention, and need to be equipped with a means for the user to manually open the door even in an event of a malfunction.

In particular, hereinafter, a description will be made based on a configuration in which the pop-up handle 31 is disposed to be elongated in parallel with the top surface of the door 30 along a left-right direction in consideration of an opening and closing direction of the door 30 of the dish washer 1, but in a case of home appliances to which the opening and closing direction of the door 30 is applied differently, such as the refrigerator and the laundry management apparatus, the pop-up handle 31 may be disposed in the door such that a longitudinal direction of the pop-up handle 31 is parallel to a vertical direction.

As described above, the pop-up handle 31 may be disposed in the door 30 of the dish washer 1 according to an embodiment of the present disclosure so as to reciprocate in a front-rear direction.

In this regard, as described above, the door 30 may be configured to be pivotable around the hinge (not shown) connected to a lower end of the door.

However, the present disclosure is not limited thereto, and a drawer-type door configured to be opened and closed in a simple horizontal movement manner along the front-rear direction (a F-R direction) is also applicable. Hereinafter, as illustrated, a description will be made based on an embodiment including the door 30 opened and closed while pivoting around the hinge connected to the lower end thereof.

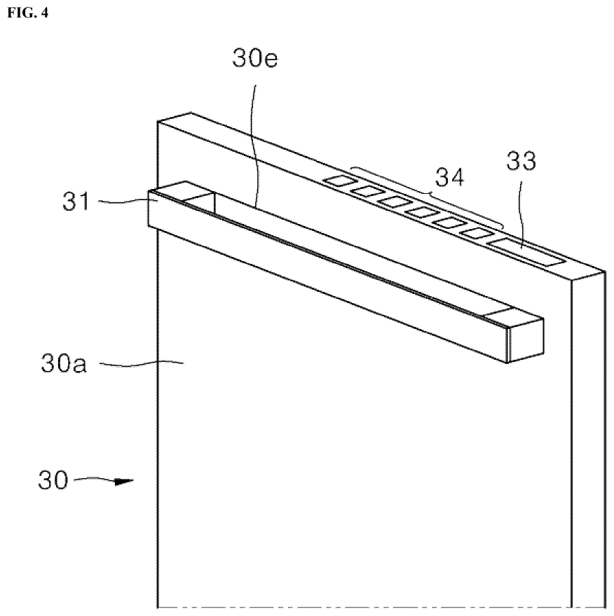

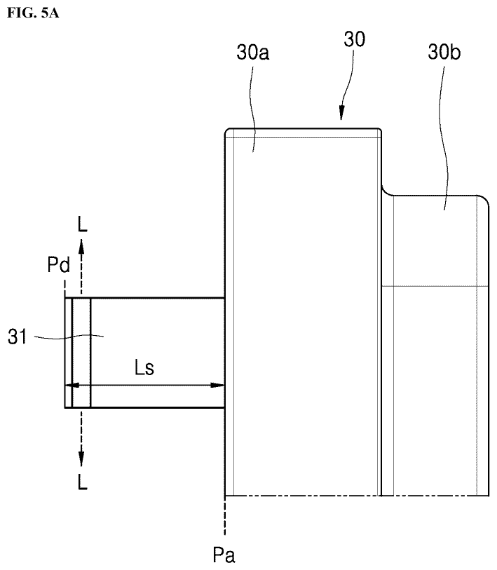

In consideration of this, as shown in FIG. 3 and FIG. 4, the pop-up handle 31 may be positioned at a position as close as possible to the top surface of the door 30 where the user may easily grip the handle.

Further, the pop-up handle 31 may be disposed so as to be retractable and extendable by passing through the front panel 30a forming the front surface of the door 30.

Further, the pop-up handle 31 may be disposed in parallel with the top surface of the door 30 along the left-right direction to facilitate the user's grip.

Further, the pop-up handle 31 may be formed to generally have a ⊏-shaped outer appearance to facilitate the user's grip.

Alternatively, when the pop-up handle 31 is formed in a form of a simple bar that fully fills an opening 30e of the front panel 30a, a blind module 37 to be described later is unnecessary, but there is a high possibility that some inconvenience may be caused when the user grips the handle for opening the door 30.

Accordingly, the ⊏-shaped outer appearance including leg areas connected to the door 30 and a grip area gripped by the user is suitable for the pop-up handle 31 such that the user may easily grip the pop-up handle 31 to completely surround the same by applying a force to open the door 30.

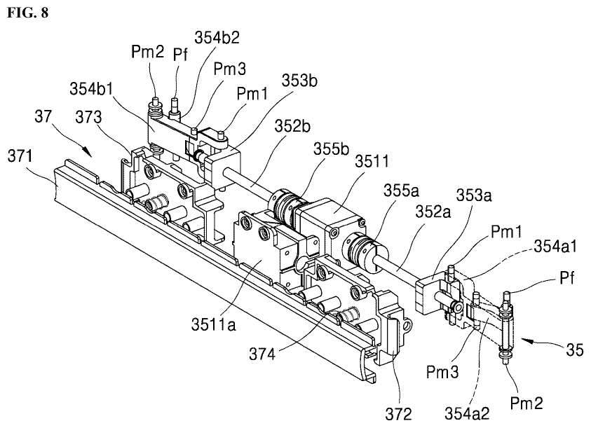

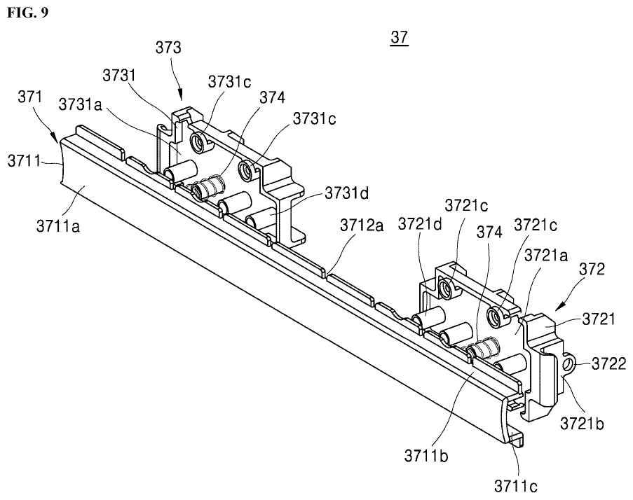

Accordingly, the pop-up handle 31 may have a through area defined in a shape surrounded by the leg areas and the grip area. Therefore, as will be described later, because of the through area of the pop-up handle 31 and the opening 30e of the front panel 30a of the door 30, the inner structure of the door 30 is inevitably exposed to the outside. A detailed configuration of the blind module 37 for covering the opening 30e will be described later with reference to FIG. 8 and subsequent drawings.

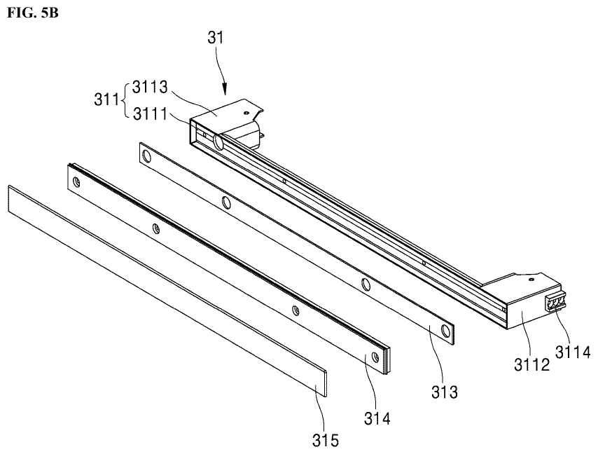

More specifically, as illustrated in FIG. 5B, to form the ⊏-shaped outer appearance, the pop-up handle 31 may include a first handle body 311 that entirely protrudes to the outside of the door 30 when the pop-up handle 31 moves frontwards, and becomes the grip area that may be gripped by the user.

Further, the pop-up handle 31 may further include a second handle body 3112 connected to a left end of the first handle body 311, extending rearwards, and becoming the leg area.

Further, the pop-up handle 31 may further include a third handle body 3113 connected to a right end of the first handle body 311, extending rearwards, and becoming the leg area.

In this regard, the second handle body 3112 and the third handle body 3113 may partially protrude to the outside of the door 30 when the pop-up handle 31 moves frontwards.

Therefore, based on the illustrated embodiment, the through area surrounded by the first handle body 311, the second handle body 3112, the third handle body 3113, and the front panel 30a of the door 30 may be defined in a vertical direction, and the user may put his/her finger in the through area to grip the first handle body 311 and pull the same when opening the door 30.

However, as described above, when the pop-up handle 31 is directed in the door such that a longitudinal direction thereof is parallel to the vertical direction (U-D direction), the through area may be defined in the left-right direction.

That is, the pop-up handle 31 may be disposed in an arbitrary area and directed along an arbitrary direction including a diagonal direction of the door 30.

In the illustrated embodiment, the second handle body 3112 and the third handle body 3113 are formed separately and forcibly fastened to both ends of the first handle body 311 through separate fastening means such as a screw bolt or the like, respectively, but they may be integrally formed with the first handle body 311.

Guide blocks 3114 may be disposed on a left side surface of the second handle body 3112 and a right side surface of the third handle body 3113, respectively.

The guide block 3114 is inserted into a guide bracket 30h1 and 30h2 of a handle frame 30d to be described later, and serves to guide a forward and rearward reciprocating motion of the handle frame 30d.

Further, the guide block 3114 may serve as a stopper that prevents the pop-up handle 31 from further moving frontwards after a movement to an extended position Pd is completed.

Further, after the pop-up handle 31 moves to the extended position Pd, the guide block 3114 may also serve to absorb a force or an impact of the user acting on the second handle body 3112 and the third handle body 3113 of the pop-up handle 31 to open the door 30.

In consideration of this, the guide block 3114 may be made of an elastic material having predetermined elasticity.

For the pop-up handle 31 to be extended and retracted, the opening 30e having a rectangular shape corresponding to the outer appearance of the pop-up handle 31 may be defined through the front panel 30a of the door 30 along the front-rear direction (the F-R direction).

The pop-up handle 31 may be configured to reciprocate in the forward and rearward directions through the opening 30e of the front panel 30a along the front-rear (F-R) direction under an operation of a handle driver 35 as will be described later.

More specifically, the pop-up handle 31 may be disposed to reciprocate in the forward and rearward directions between the most forward position and the most rearward position under the operation of the handle driver 35.

For convenience, the most forward position to which the pop-up handle 31 is moved in a forward direction is defined as an extended position Pd. The most rearward position to which the pop-up handle 31 is moved in a rearward direction is defined as a retracted position Pa.

FIG. 3 illustrates a state where the pop-up handle 31 has been moved to the most rearward position, that is, the retracted position Pa, and thus has been retracted into the inside of the door 30.

As shown, when the pop-up handle 31 has been moved to the retracted position Pa, the pop-up handle 31 may be in a state of being entirely or partially retracted into the inside of the door 30.

In this regard, illustratively, the pop-up handle 31 may pass through an entirety of the opening 30e of the door 30 and be retracted into the inside of the door 30.

Furthermore, when the pop-up handle 31 has been moved to the retracted position Pa, the pop-up handle 31 may be in a state where the pop-up handle 31 does not protrude from the front panel 30a of the door 30 in a frontward direction.

Furthermore, when the pop-up handle 31 has been moved to the retracted position Pa, a front end surface of the pop-up handle 31 may be coplanar with a front surface of the front panel 30a of the door 30 so as to form a continuous surface.

That is, the front end surface of the pop-up handle 31 at the retracted position Pa may be in a state parallel to the front panel 30a.

Therefore, a state in which no step is formed between the front surface of the front panel 30a of the door 30 and the front end surface of the pop-up handle 31 may be formed.

Thus, when the pop-up handle 31 has been moved to the retracted position Pa, the opening 30e of the front panel 30a may bs entirely blocked.

Further, when the pop-up handle 31 has been moved to the retracted position Pa, no step is formed between the front surface of the front panel 30a and the front end surface of the pop-up handle 31, such that the phenomenon in which foreign substances such as dust accumulate on an convex portion formed at the front surface of the door 30 or on the handle itself as in the conventional approach may be fundamentally prevented.

In one example, as shown in FIG. 5B, the front end surface of the pop-up handle 31 may be a front surface of a decoration panel 315 that is provided separately from a first handle body 311, a second handle body 3112, and a third handle body 3113 that constitute the outer appearance of the pop-up handle 31.

In this regard, the front surface of the decoration panel 315 may include a material having the same texture and the same color as those of the front panel 30a of the door 30.

Accordingly, a sense of unity between the decoration panel 315 and the front panel 30a of the door 30 may be generated.

In addition, aesthetic sensibility of the outer appearance of the door 30 may be improved, and aesthetics of the door which the user perceives may be improved.

FIG. 4 and FIG. 5A illustrate a state in which the pop-up handle 31 has been moved from the retracted position Pa to the extended position Pd as the most forward position.

The door 30 of the dish washer 1 should be opened and closed in order to store the dishes that need to be washed in the dish washer or to withdraw the dishes that have been washed out of the dish washer 1.

When the user's intention to open the door 30 is identified at a time when opening/closing of the door 30 is required, the pop-up handle 31 may be automatically moved from the retracted position Pa to the extended position Pd under the operation of the handle driver 35.

To this end, the dish washer 1 according to an embodiment of the present disclosure may further be provided with a means for detecting the user's intention to open the door 30.

For example, the means for detecting the user's intention to open the door 30 may include a proximity sensor (not shown).

The proximity sensor may be a sensor that may detect whether the user approached so as to be located within a specific range from the door 30.

For example, the proximity sensor may include any one of a radar sensor, an image sensor, or an infrared (IR) sensor.

To effectively identify whether the user is in proximity, the proximity sensor may be disposed on at least one of the top surface, a bottom surface, and the front surface of the door 30.

Further, a means for detecting the user's intention to open the door 30 may include a touch sensor (not shown).

Illustratively, the touch sensor may include any one of capacitive type, resistive type, and pressure type touch sensors.

The touch sensor may be disposed in the pop-up handle 31 so as to effectively identify the intention to open or close the door 30.

Illustratively, the touch sensor may be mounted on a handle substrate 313 together with a lighting element as will be described later.

When the user's intention is identified, the pop-up handle 31 may be automatically moved forward to the extended position Pd as shown in FIGS. 4 and 5A.

When the movement of the pop-up handle 31 to the extended position Pd is completed as described above, a state in which the first handle body 311 of the pop-up handle 31 is entirely exposed to the outside of the door 30 may be formed.

Further, when the movement of the pop-up handle 31 to the extended position Pd is completed, a state in which the user is able to grip the handle may be formed.

In this regard, a stroke Ls in which the pop-up handle 31 is moved from the retracted position Pa to the extended position Pd may be, for example, equal to or greater than 40 mm and equal to or smaller than 50 mm.

Preferably, the stroke Ls in which the pop-up handle 31 is moved from the retracted position Pa to the extended position Pd may be 45 mm.

Determination of the stroke Ls of the pop-up handle 31 as such is made in consideration of the fact that it is not easy for the user to grip the pop-up handle 31 when the stroke Ls is too small, such as smaller than 40 mm, and the fact that a size of the pop-up handle 31 in the front-rear direction is increased and thus the pop-up handle 31 is not entirely retracted into the door 30 when the stroke Ls is too great, such as exceeding 50 mm.

However, the movement stroke Ls of the pop-up handle 31 as such is merely an example, and may be set differently depending on an overall size of the dish washer 1 and a size in the front-rear direction of the door 30.

In one example, as the pop-up handle 31 is moved to the extended position Pd, the first handle body 311 of the pop-up handle 31 may exit the opening 30e of the front panel 30a of the door 30 and be entirely exposed and protrude to the outside of the door 30.

Accordingly, the closed state of the opening 30e of the front panel 30a is at least partially released by the pop-up handle 31.

However, as will be described later, when the pop-up handle 31 is moved to the extended position Pd, a blind panel 371 of a blind module 37 is moved forward together in association with the first handle body 311.

Accordingly, the opening 30e of the front panel 30a that is opened based on the movement of the pop-up handle 31 may be covered by the blind module 371.

Accordingly, even when the pop-up handle 31 is moved to the extended position Pd, the opening 30e of the front panel 30a may be maintained in the closed state or the covered state.

Accordingly, the foreign substances such as dust may be effectively prevented from passing through the opening 30e and being introduced into the door 30.

Further, observation of the inside of the door 30 through the opening 30e of the front panel 30a becomes unavailable by the blind module 371.

Accordingly, deterioration of the aesthetics of the door which the user perceives may be effectively prevented.

A detailed configuration of the blind module 37 including the blind panel 371 will be described later with reference to FIGS. 8 to 15.

In one example, the pop-up handle 31 of the dish washer 1 according to an embodiment of the present disclosure may be configured to allow the user to visually recognize that the pop-up handle 31 is being normally driven.

For example, as illustrated in FIG. 5B, a means for the visual recognition may include the handle substrate 313 disposed in front of the first handle body 311 and on which at least one lighting element is mounted.

In addition, the means for the visual recognition may include a light guide plate 314 that is disposed in front of the handle substrate 313 and diffuses the visible light L generated from the lighting element.

As illustrated, the handle substrate 313 and the light guide plate 314 may be disposed between the decoration panel 315 and the first handle body 311.

Although not shown, the lighting element may be applied without limitation as long as it is a means capable of receiving power and generating the predetermined visible light L, and may be exemplarily an LED element.

The light guide plate 314 serves to diffuse the visible light L generated from the lighting element.

More specifically, the visible light L generated from a lighting element 3131 may be introduced into a front surface or a rear surface of the light guide plate 314, then may be uniformly dispersed inside the light guide plate 314, and then may be diffused toward an outer edge of the light guide plate 314.

In this regard, the decoration panel 315 disposed in front of the light guide plate 314 is surface-treated to have the same texture as the front panel 30a of the door 30 as described above.

Accordingly, the visible light L introduced into the light guide plate 314 may not pass through the decoration panel 315 and may be projected to the outside through the outer edge of the light guide plate 314.

To project the visible light L to the outside as such, as shown in FIG. 5A, the edge of the light guide plate 314 may be in a state of being exposed to the outside.

That is, the light guide plate 314 is disposed in a state of being sandwiched between the decoration panel 315 and the front surface of the first handle body 311.

In this regard, the outer edge of the light guide plate 314 may be disposed in a state not covered by them.

Accordingly, as illustrated, the visible light L generated from the lighting element 3131 may be effectively projected to the outside through the outer edge of the light guide plate 314 via the inside of the light guide plate 314.

Accordingly, the user may effectively check whether the pop-up handle 31 is in operation and an operating state thereof with the visible light L projected through the outer edge of the light guide plate 314.

Further, because the visible light L is projected only through the outer edge of the light guide plate 314, a lighting effect similar to an indirect light may be achieved. Accordingly, the aesthetic sensibility perceived by the user may be improved.

### Detailed Configuration of Handle Driver and Handle Frame

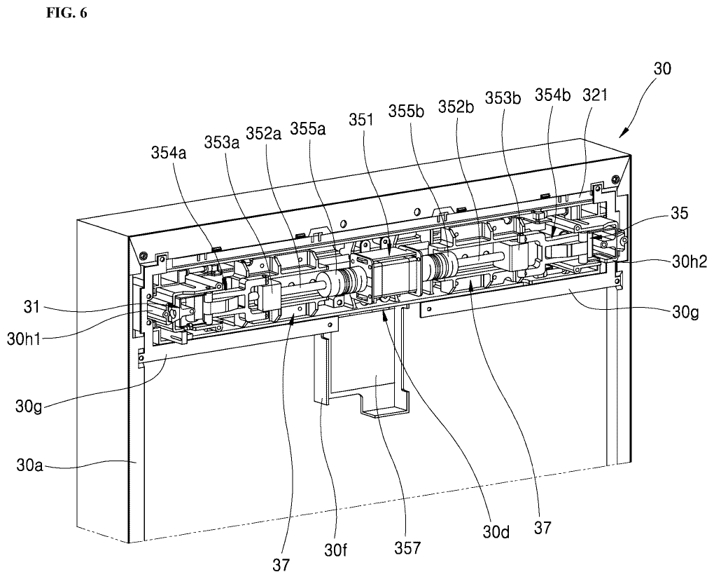

Hereinafter, a detailed configuration of the handle driver 35 that drives the pop-up handle 31 so as to reciprocate frontwards and rearwards between the extended position Pd and the retracted position Pa will be described with reference to FIGS. 6 to 17.

First, referring to FIGS. 6 to 8, the handle driver 35 may include a driving motor 351 that receives the power and generates a rotational driving force.

In this regard, as described above, the driving motor 351 constituting the handle driver 35 may be provided as a single unit.

Accordingly, rotational driving forces to be respectively provided to a left end of the pop-up handle 31 and a right end of the pop-up handle 31 may be collectively generated by the driving motor 351.

As described above, as the handle driver 35 is constructed to include only the single driving motor 351, the number of components constituting the dish washer 1 may be reduced.

Further, a space occupied by the handle driver 35 inside the door 30 may be effectively reduced, and accordingly, space utilization for the inside of the door 30 may be improved.

A motor body 3511 of the driving motor 351 may be disposed at a position intermediate between the left end of the pop-up handle 31 and the right end of the pop-up handle 31 with respect to the pop-up handle 31 so as to collectively generate the rotational driving forces toward the left end of the pop-up handle 31 and the right end of the pop-up handle 31.

Further, the motor body 3511 may output the rotational driving forces in both directions so as to collectively generate the rotational driving forces.

More specifically, as illustrated, the driving motor 351 may include a first output shaft 3512a extending along a horizontal direction toward the second handle body 3112 constituting the left end of the pop-up handle 31.

Based on the illustrated embodiment, the first output shaft 3512a may pass through a left side surface of the motor body 3511 and extend along the horizontal direction toward the second handle body 3112.

Further, the driving motor 351 may include a second output shaft 3512b extending along the horizontal direction toward the third handle body 3113 constituting the right end of the pop-up handle 31.

Based on the illustrated embodiment, the second output shaft 3512b may pass through a right side surface of the motor body 3511 and extend along the horizontal direction toward the third handle body 3113.

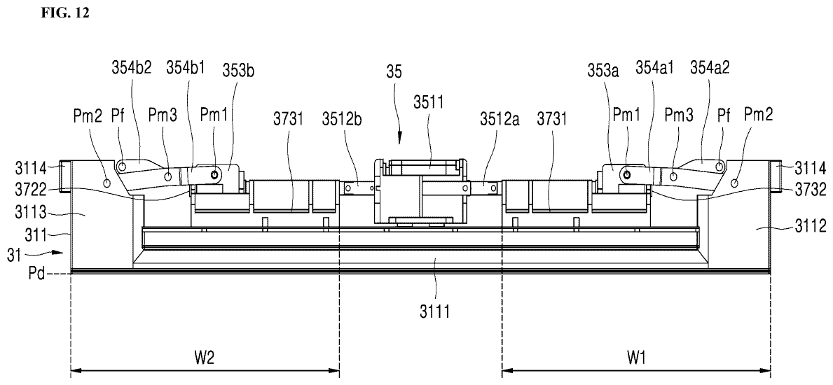

In this regard, as illustrated in FIG. 12, a first spacing W1 may be formed between the first output shaft 3512a of the driving motor 351 and a left end of the second handle body 3112 of the pop-up handle 31 with respect to the left-right direction (the Le-Ri direction).

Further, as illustrated in FIG. 12, a second spacing W2 may be formed between the second output shaft 3512b of the driving motor 351 and a right end of the third handle body 3113 of the pop-up handle 31 with respect to the left-right direction (the Le-Ri direction).

In this case, the first spacing W1 and the second spacing W2 may be equal to each other.

As will be described later, a rotational driving force of the first output shaft 3512a may be transmitted to a first lead screw 352a via a first coupler 355a.

Further, a rotational driving force of the second output shaft 3512b may be transmitted to a second lead screw 352a via a second coupler 355b.

As the first spacing W1 and the second spacing W2 are set to be equal to each other as such, the first lead screw 352a and the second lead screw 352b having the same length and shape may be applied.

That is, the first lead screw 352a and the second lead screw 352b may be disposed so as to be interchangeable with each other. Accordingly, common use of components may be enabled.

As described above, the pop-up handle 31 of the dish washer 1 according to an embodiment of the present disclosure may be configured to reciprocate between the extended position Pd and the retracted position Pa as the forward movement from the retracted position Pa toward the extended position Pd and the rearward movement from the extended position Pd toward the retracted position Pa are repeatedly performed.

To easily implement such repetitive reciprocating motion, the driving motor 351 constituting the handle driver 35 may be configured to generate bidirectional rotational driving forces.

Therefore, any type of motor capable of generating the bidirectional rotational driving forces as described above may be applied without limitation as the driving motor 351 applied to the handle driver 35 of the dish washer 1 according to an embodiment of the present disclosure.

Hereinafter, driving in a direction in which the output shaft 3512 of the driving motor 351 rotates for the forward movement of the pop-up handle 31 toward the extended position Pd between the bidirectional rotational driving forces will be referred to as forward rotational driving or a forward rotational driving force.

Further, driving in a direction in which the output shaft 3512 of the driving motor 351 rotates for the rearward movement of the pop-up handle 31 toward the retracted position Pa between the bidirectional rotational driving forces will be referred to as reverse rotational driving or a reverse rotational driving force.

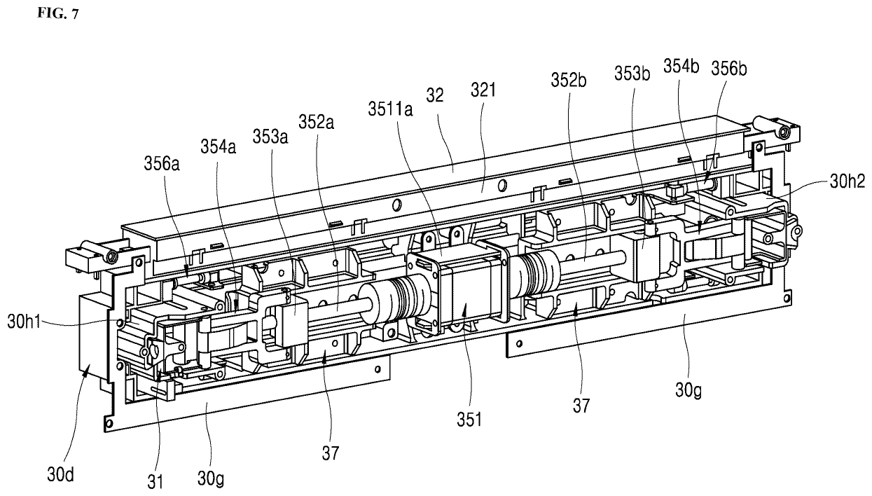

In one example, as illustrated in FIGS. 6 and 7, the motor body 3511 of the driving motor 351 may be fixed to the inside of the handle frame 30d.

More specifically, the motor body 3511 of the driving motor 351 may be forcibly coupled to a rear surface of a front wall 30d11 of a frame body 30d1 of the handle frame 30d through a fastening means such as a screw in a state of being accommodated in a motor bracket 3511a having a hollow box shape.

To prevent interference with the first output shaft 3512a and the second output shaft 3512b extending along the left-right direction (the Le-Ri direction) and to avoid them, a plurality of fastening tabs having screw holes may be integrally formed with a top surface and a bottom surface of the motor bracket 3511a.

As will be described later, multiple first screw bosses 30d5 may be integrally formed with a rear surface of the front wall 30d11 of the frame body 30d1 to protrude therefrom in correspondence with positions of the plurality of fastening tabs.

In one example, the handle driver 35 may further include a pair of lead screws 352a and 352b.

The pair of lead screws 352a and 352b serve to transmit the rotational driving forces generated from the driving motor 351 to motion converters 353a, 354a, 353b, and 354b to be described later.

More specifically, the pair of lead screws 352a and 352b may include the first lead screw 352a that is connected to the first output shaft 3512a of the driving motor 351 and rotates by receiving the rotational driving force from the first output shaft 3512a.

For example, the first lead screw 352a may have a cylindrical shape extending along the left-right direction, similar to the first output shaft 3512a.

Further, the first lead screw 352a may be connected to the first output shaft 3512a in a state in which it is able to rotate but is not able to move along the front-rear direction (the F-R direction) or the left-right direction (the Le-Ri direction).

To this end, a right end of the first lead screw 352a may be connected to the first output shaft 3512a so as to rotate integrally with the first output shaft 3512a.

Further, a left end of the first lead screw 352a may be rotatably supported by a bushing 3722 of a first bracket 372 of the blind module 37 to be described later.

In one example, a male screw thread having a predetermined longitudinal width may be formed on an outer circumferential surface of the left end of the first lead screw 352a.

A first nut 353a constituting a first motion converter 353a and 354a as described later may be screw-coupled to the male screw thread.

As will be described later, as the first nut 353a linearly moves along the left-right direction (the Le-Ri direction) by a forward rotation or a reverse rotation of the first lead screw 352a, the rotational driving force of the first lead screw 352a may be converted into a linear driving force in the left-right direction (the Le-Ri direction) by the first nut 353a.

To secure a predetermined margin for a linear movement range of the first nut 353a, the longitudinal width of the male thread formed on the first lead screw 352a may be slightly greater than the linear movement range in the left-right direction of the first nut 353a.

Further, the pair of lead screws may include a second lead screw 352a that is connected to the second output shaft 3512b of the driving motor 351 and rotates by receiving the rotational driving force from the second output shaft 3512b.

For example, the second lead screw 352b may have the cylindrical shape extending along the left-right direction, similar to the second output shaft 3512b.

Further, the second lead screw 352b may be connected to the second output shaft 3512b in a state in which it is able to rotate but is not able to move along the front-rear direction (the F-R direction) or the left-right direction (the Le-Ri direction).

To this end, a left end of the second lead screw 352b may be connected to the second output shaft 3512b to rotate integrally with the second output shaft 3512b.

Further, a right end of the second lead screw 352b may be rotatably supported by a bushing 3732 of a second bracket 373 of the blind module 37 to be described later.

In one example, a male screw thread having a predetermined longitudinal width may be formed on an outer circumferential surface of the right end of the second lead screw 352b.

A second nut 353b constituting a second motion converter 353b and 354b as described later may be screw-coupled to the male screw thread.

As will be described later, as the second nut 353b linearly moves along the left-right direction (the Le-Ri direction) by a forward rotation or a reverse rotation of the second lead screw 352b, the rotational driving force of the second lead screw 352b may be converted into a linear driving force in the left-right direction (the Le-Ri direction) by the second nut 353b.

To secure a predetermined margin for a linear movement range of the second nut 353b, the longitudinal width of the male thread formed on the second lead screw 352b may be slightly greater than a linear movement range in the left-right direction of the second nut 353b.

As described above, the first lead screw 352a and the second lead screw 352b may have the same length and shape.

Accordingly, the first lead screw 352a and the second lead screw 352b may be disposed so as to be interchangeable with each other. Accordingly, the common use of the components may be enabled.

In one example, the handle driver 35 may further include a pair of couplers 355a and 355b.

More specifically, the pair of couplers 355a and 355b may include the first coupler 355a connecting the first output shaft 3512a of the driving motor 351 with the first lead screw 352a such that they rotate integrally with each other.

Further, the pair of couplers 355a and 355b may include the second coupler 355b connecting the second output shaft 3512b of the driving motor 351 with the second lead screw 352a such that they rotate integrally with each other.

Through the first coupler 355a, even when the first output shaft 3512a of the driving motor 351 and the first lead screw 352a are not arranged on the same rotation axis, the rotational driving force of the first output shaft 3512a may be effectively transmitted to the first lead screw 352a.

Further, through the second coupler 355a, even when the second output shaft 3512b of the driving motor 351 and the second lead screw 352b are not arranged on the same rotation axis, the rotational driving force of the second output shaft 3512b may be effectively transmitted to the second lead screw 352b.

In the same manner as the first lead screw 352a and the second lead screw 352b, the first coupler 355a and the second coupler 355a may be disposed so as to be interchangeable with each other.

In one example, the handle driver 35 may further include a pair of motion converters.

First, as shown in FIG. 8, the pair of motion converters may include the first motion converter 353a and 354a that converts the rotational driving force transmitted from the first lead screw 352a into a linear driving force in the front-rear direction (the F-R direction).

The linear driving force in the front-rear direction (the F-R direction) converted through the first motion converter 353a and 354a may be transmitted to the second handle body 3112 forming the left end of the pop-up handle 31.

In more detail, the first motion converter 353a and 354a may include the first nut 353a screw-coupled to the male screw of the first lead screw 352a described above.

Illustratively, the first nut 353a may have an outer appearance having an inverted L-shape when viewed from above.

The first lead screw 352a may be screw-coupled to a first part forming the inverted L-shape and extending in the front-rear direction.

A female screw to which the male screw thread of the first lead screw 352a is screw-coupled may be formed through the first part along the left-right direction.

One end of the first link 354a to be described later may be connected, in a relatively rotatable manner, to a second part forming the inverted L-shape and extending leftwards from a rear edge of the first part.

One end of the first link 354a may be connected, in a relatively rotatable manner, to the second part of the first nut 353a through a first moving pin Pm1.

A pin insertion hole may be defined through the second part of the first nut 353a along the vertical direction (the U-D direction) such that the first moving pin Pm1 may be inserted thereinto and coupled thereto along the vertical direction (the U-D direction).

In one example, the first motion converter 353a and 354a may further include the first link 354a that converts the linear driving force in the left-right direction (the Le-Ri direction) transmitted from the first nut 353a into the linear driving force in the front-rear direction (the F-R direction).

Illustratively, the first link 354a may include a pair of links including a first driving link 354a1 and a first driven link 354a2.

As illustrated, one end of the first driving link 354a1 may be furcated into a fork shape and the other end thereof may have a simple plate shape.

As described above, the one end of the first driving link 354a1 furcated into the fork shape may be connected, in a relatively rotatable manner, to the second part of the first nut 353a through the first moving pin Pm1.

In one example, the other end of the first driving link 354a1 having the simple plate shape may be connected, in a relatively rotatable manner, to the third handle body 3113 through a second moving pin Pm2.

In this regard, upper and lower ends of the second moving pin Pm2 may be inserted into a pin guide slit 30h11 defined through the first guide bracket 30h1 to be described later.

As will be described later, the pin guide slit 30h11 may be a long hole extending along the front-rear direction (the F-R direction) to guide the movement direction of the pop-up handle 31.

Accordingly, the other end of the first driving link 354a1 and the second handle body 3112 may be guided in a movement direction so as to linearly move along the front-rear direction (the F-R direction) by the second moving pin Pm2 and the pin guide slit 30h11.

As illustrated, the one end of the first driving link 354a1 may be furcated into the fork shape and the other end thereof may have the simple plate shape.

In one example, the first driven link 354a2 serves to allow a center of rotation of an entirety of the first driving link 354a to be formed between one end and the other end in the process in which the first nut 353a1 linearly moves along the left-right direction (the Le-Ri direction), and serves to vary the center of rotation of the entirety of the first driving link 354a1.

To this end, one end of the first driven link 354a2 may be connected, in a relatively rotatable manner, to a third moving pin Pm3 at an intermediate position between one end and the other end of the first driven link 354a2.

In one example, the other end of the first driven link 354a1 may be connected, in a relatively rotatable manner, to a pin hole 30h13 of the first guide bracket 30h1 through a fixing pin Pf such that the rotation center of the entirety of the first driving link 354a2 may vary.

Unlike the other end of the first driving link 354a1, the other end of the first driven link 354a2 is connected to the pin hole 30h13, which is a simple circular hole, through the fixing pin Pf. Accordingly, the other end of the first driven link 354a2 may be connected to the inside of the first guide bracket 30h1 in a state of being able to rotate, but not able to move along the front-rear direction (the F-R direction) or the left-right direction (the Le-Ri direction).

To increase a connection strength to the first guide bracket 30h1, the other end of the first driven link 354a2 may be formed in a cylindrical shape having a hollow.

In one example, as illustrated, the third moving pin Pm3 may be disposed at a position closer to the first moving pin Pm1 than to the second moving pin Pm2.

Accordingly, an amount of rotation at the other end of the first driving link 354a1 may be greater than an amount of rotation at one end of the first driving link 354a1 with respect to the third moving pin Pm3 serving as the center of rotation of the entirety of the first driving link 354a1.

Accordingly, even when an amount of linear movement of the first nut 353a in the left-right direction (the Le-Ri direction) is not increased, the stroke Ls in which the first driving link 354a1 pushes or pulls the second handle body 312 of the pop-up handle 31 may be effectively secured.

In one example, the pair of motion converters may include the second motion converter 353b and 354b that converts the rotational driving force transmitted from the second lead screw 352b into a linear driving force in the front-rear direction (the F-R direction).

As described above, the first motion converter 353a and 354a and the second motion converter 353b and 354b are configured to be driven through the single driving motor 351.

Accordingly, the first motion converter 353a and 354a and the second motion converter 353b and 354b may be disposed at positions symmetrical to each other with respect to a vertical surface that equally divides the pop-up handle 31 along the horizontal direction, such that the rotational driving forces are equally transmitted to the first motion converter 353a and 354a and the second motion converter 353b and 354b.

Further, for the same reason, the first motion converter 353a and 354a and the second motion converter 353b and 354b may have shapes symmetrical to each other with respect to the vertical surface that equally divides the pop-up handle 31 along the horizontal direction.

Accordingly, the second nut 353b constituting the second motion converter 353b and 354b may be disposed at a position symmetrical to a position of the first nut 353a of the first motion converter 353a and 354a and formed in a shape symmetrical to a shape thereof.

Further, a detailed configuration of the second link 354b constituting the second motion converter 353b and 354b and including a second driving link 354b1 and a second driven link 354b2 may be disposed at a position symmetrical to a position of the first link 354a of the first motion converters 353a and 354a and formed in a shape symmetrical to a shape thereof.

As the second motion converter 353b and 354b is disposed at the position symmetrical to the position of the first motion converter 353a and 354a and formed in the shape symmetrical to a shape thereof, a description of redundant contents regarding the second motion converter 353b and 354b will be omitted below.

In one example, as described above, in the present disclosure, the pop-up handle 31 is driven through the first motion converter 353a and 354a and the second motion converter 353b and 354b, which are disposed at the positions symmetrical to each other and formed in the shapes symmetrical to each other, through the single driving motor 351.

Accordingly, there is a possibility that the stroke Ls of the pop-up handle 31, which is moved from the retracted position Pa to the extended position Pd, may be different at the second handle body 3112 and the third handle body 3113 because of machining tolerances and assembly tolerances of the first motion converter 353a and 354a, the second motion converter 353b and 354b, and the pop-up handle 31.

That is, there is a high possibility that a positional deviation in the front-rear direction (the F-R direction) occurs between the second handle body 3112 and the third handle body 3113.

When the positional deviation in the front-rear direction (the F-R direction) between the second handle body 3112 and the third handle body 3113 occurs to a predetermined level or higher, a load of the driving motor 351 may increase rapidly.

Further, loads of the first motion converter 353a and 354a and the second motion converter 353b and 354b that convert the driving forces and transmit the converted driving forces to the second handle body 3112 and the third handle body 3113, respectively, may also increase rapidly, and thus there is a possibility that the first motion converter 353a and 354a and the second motion converter 353b and 354b may be damaged.

Further, damage to the second handle body 3112 and the third handle body 3113 constituting the pop-up handle 31 may be caused.

As a means for minimizing the positional deviation between the second handle body 3112 and the third handle body 3113 that may occur in the forward and rearward reciprocating motion of the pop-up handle 31, the handle driver 35 of the pop-up handle 31 of the dish washer 1 according to an embodiment of the present disclosure may include a positional deviation adjustor 356a and 356b.

In more detail, as illustrated in FIG. 7, the positional deviation adjustors 356a and 356b may include a first deviation adjustor 356a that adjusts a position of the second handle body 3112 in the front-rear direction (the F-R direction), and a second deviation adjustor 356b that adjusts a position of the third handle body 3113 in the front-rear direction (the F-R direction).

The first deviation adjustor 356a and the second deviation adjustor 356b may be configured to apply forces to push the second handle body 3112 and the third handle body 3113 forward or rearward, respectively, when the deviation occurs between the position of the second handle body 3112 in the front-rear direction (the F-R direction) and the position of the third handle body 3113 in the front-rear direction (the F-R direction).

The first deviation adjustor 356a and the second deviation adjustor 356b may be arranged at positions symmetrical to each other with respect to the vertical surface that equally divides the pop-up handle 31 along the horizontal direction so as to apply the forces to push the second handle body 3112 and the third handle body 3113 in a direction that minimizes the positional deviation.

In addition, for the same reason, the first deviation adjustor 356a and the second deviation adjustor 356b may have shapes symmetrical to each other with respect to the vertical surface that equally divides the pop-up handle 31 along the horizontal direction.

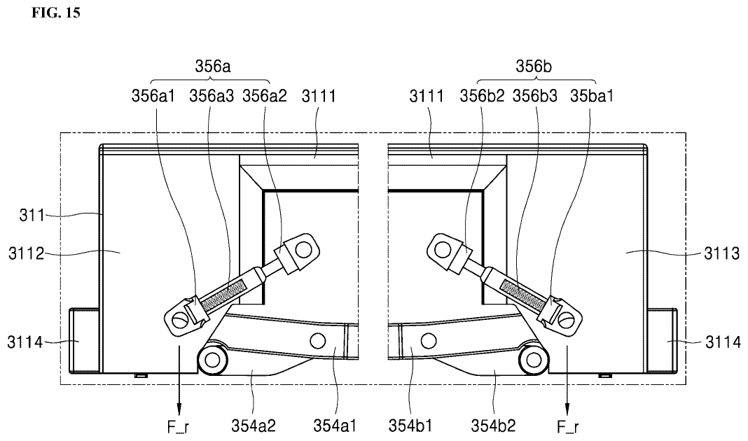

A detailed configuration of the positional deviation adjustor 356a and 356b including the first deviation adjustor 356a and the second deviation adjustor 356b will be described later with reference to FIGS. 15 to 17.

In one example, the dish washer 1 according to an embodiment of the present disclosure may include the blind module 37 that covers the opening 30e through which the pop-up handle 31 passes when the pop-up handle 31 moves from the retracted position Pa to the extended position Pd.

As described above, when the pop-up handle 31 is moved to the extended position Pd, the opening 30e of the front panel 30a defined through the front panel 30a in the front-rear direction (the F-R direction) to allow the pop-up handle 31 to pass therethrough is at least partially opened except for portions occupied by the second handle body 3112 and the third handle body 3113.

The blind module 37 serves to cover or cover the opening 30e and a handle entrance 30d2 such that external foreign substances are not introduced or the inside of the door 30 is not observed through the opening 30e that is at least partially opened forward and the handle entrance 30d2 of the handle frame 30d to be described later.

First, as illustrated in FIGS. 8 and 9, illustratively, the blind module 37 may include the blind panel 371 that is movable along the front-rear direction (the F-R direction) in association with the forward and rearward reciprocating motion of the pop-up handle 31.

More specifically, the blind panel 371 may include a panel body 3711 having a plate shape that covers the opening 30e and the handle entrance 30d2.

The panel body 3711 may have a rectangular shape corresponding to shapes of the opening 30a and the handle entrance 30d2.

A width of the panel body 3711 in the left-right direction may be set to be equal to or slightly smaller than a width in the left-right direction of a space between the second handle body 3112 and the third handle body 3113 so as to cover the opening 30e and the handle entrance 30d2 that are partially opened after the pop-up handle 31 is moved to the extended position Pd.

When the opening 30e and the handle entrance 30d2 are covered by the panel body 3711, a front end surface 3711a of the panel body 3711 is exposed to the outside through the opening 30e and the handle entrance 30d2.

To minimize a sense of difference with respect to the front panel 30a, the front end surface 3711a of the panel body 3711 may be surface-treated to have the same texture and the same color as the front surface of the front panel 30a.

In addition, when the opening 30e and the handle entrance 30d2 are covered by the panel body 3711, the front end surface 3711a of the panel body 3711 may form a continuous surface with the front surface of the front panel 30a, or may be in a state of slightly protruding from the front panel 30a.

Accordingly, as the front end surface 3711a forms the same surface as the front surface of the front panel 30a and is disposed to slightly protrude from the front panel 30a, the foreign substances such as dust or the like may be prevented from being accumulated in the opening 30e and the handle entrance 30d2.

The blind panel 371 may further include a flange 3712 formed at an upper end surface 3711b and a lower end surface 3711c of the panel body 3711.

When a covering position is reached, the front end surface 3711a of the panel body 3711 needs to form the continuous surface with the front surface of the front panel 30a or stop in the state of slightly protruding from the front panel 30a.

The flange 3712 serves as a stopper that prevents the panel body 3711 from moving further frontwards from the most forward position after reaching the most forward position.

In consideration of the shape of the panel body 3711, the flange 3712 may linearly extend along a rear edge of the upper end surface 3711b of the panel body 3711.

In addition, the flange 3712 may linearly extend along a rear edge of the lower end surface 3711c of the panel body 3711.

In addition, a height at which the flange 3712 protrudes from the upper end surface 3711b of the panel body 3711 and a height at which the flange 3712 protrudes from the lower end surface 3711c of the panel body 3711 may be uniformly maintained from a left end to a right end of the panel body 3711.

As will be described later, when the panel body 3711 moves to the most forward position, the flange 3712 may come into contact with and collide with a rear edge of an entrance rib 30d3 of the handle frame 30d, and thus the panel body 3711 may stop at the most forward position.

In one example, as in the illustrated embodiment, multiple slits 3712a may be defined in the flange 3712.

The multiple slits 3712a may extend from an upper edge to a lower edge of the flange 3712 along the vertical direction (the U-D direction).

In addition, widths of the multiple slits 3712a in the left-right direction may be set to be substantially equal to each other.

In addition, multiple reinforcing ribs 30d4 formed inside the handle frame 30d to be described later may be inserted into the multiple slits 3712a.

As will be described later, a thickness of each reinforcing rib 30d4 is substantially uniformly maintained along the front-rear direction (the F-R direction).

In addition, the width of each of the multiple slits 3712a in the left-right direction may be equal to or slightly greater than the thickness of the reinforcing rib 30d4 of the handle frame 30d.

As described above, as the blind panel 371 is disposed such that the reinforcing ribs 30d4 of the handle frame 30d are inserted into the respective slits 3712a, the slits 3712a of the flange 3712 and the reinforcing ribs 30d4 of the handle frame 30d may serve as guide means for guiding the forward and rearward reciprocating motion of the blind panel 371.

In one example, the blind panel 371 may be connected to the first bracket 372 and the second bracket 373, which will be described later, such that spacings therebetween in the front-rear direction (the F-R direction) are variable.

At least one first protrusion 3711d protruding toward the first bracket 372 and the second bracket 373 may be disposed on a rear surface of the panel body 3711 so as to be connected to the first bracket 372 and the second bracket 373 in a state in which such a variable spacings are defined.

In the illustrated embodiment, a configuration of being connected to the first bracket 372 through a total of four first protrusions 3711d and being connected to the second bracket 373 through a total of four first protrusions 3711d is illustrated.

However, this is merely an example. The number of first protrusions 3711d may be adjusted depending on a width in the left-right direction or a width in the vertical direction of the blind panel 371.

The first protrusion 3711d may be connected in a telescopic manner such that the spacing in the front-rear direction (the F-R direction) is variable.

To be connected in the telescopic manner, the first protrusion 3711d may be a solid rib, and a second protrusion 3721d into which the first protrusion 3711d is coupled and inserted may be a hollow rib.

As will be described later, the second protrusion 3721d may protrude from a front surface 3721a of the first bracket 372 and a front surface 3731a of the second bracket 373 toward the panel body 3711.

In addition, the blind module 37 may include a bracket 372 and 373 that supports the blind panel 371 so as to be relatively movable.

In this regard, for the shape of the blind panel 371 in which the left-right direction (the Le-Ri direction) becomes a longitudinal direction and to prevent interference with the driving motor 351 disposed at the rear of the blind panel 371, illustratively, the bracket 372 and 373 may be divided into the first bracket 372 and the second bracket 373.

The first bracket 372 serves to support a left portion of the blind panel 371 so as to be relatively movable and to prevent the blind panel 371 from deviating rearwards.

At least one second protrusion 3721d protruding toward the left portion of the blind panel 371 may be disposed on the front surface 3721a of a bracket body 3721 of the first bracket 372 so as to support the left portion of the blind panel 371 in a relatively moveable manner, that is, to allow the spacing between the blind panel 371 and the first bracket 372 in the front-rear direction (the F-R direction) to vary.

As in the embodiment, when a total of four first protrusions 3711d are disposed on the rear surface of the blind panel 371, a total of four second protrusions 3721d may be disposed on the front surface 3721a of the bracket body 3721 of the first bracket 372 in correspondence thereto.

As described above, each second protrusion 3721d of the first bracket 372 may be the hollow rib so as to be telescopically connected to the first protrusion 3711d of the blind panel 371.

The hollow defined inside the second protrusion 3721d of the first bracket 372 may be continuously defined from a front end of the second protrusion 3721d to a rear surface of the bracket body 3721 of the first bracket 372.

The first bracket 372 may be fastened to the handle frame 30d to be described later.

To fasten the handle frame 30d, the first bracket 372 may include a plurality of fastening bosses 3721c through which screw holes are defined along the front-rear direction (the F-R direction).

Illustratively, the plurality of fastening bosses 3721c of the first bracket 372 may be provided as a pair close to an upper surface of the bracket body 3721 of the first bracket 372, and may be provided as a pair close to a lower surface of the bracket body 3721 of the first bracket 372.

In correspondence to the plurality of fastening bosses 3721c of the first bracket 372, two pairs of second screw bosses 30d6 arranged with the handle entrance 30d2 interposed therebetween may be integrally formed inside the handle frame 30d.

In one example, as described above, the first bracket 372 may also serve to rotatably support the first lead screw 352a.

To this end, the bushing 3722 may be integrally formed with a left end surface 3721b of the bracket body 3721 of the first bracket 372.

The bushing 3722 may include a circular hole defined therethrough along the left-right direction.

The left end of the first lead screw 352a may be rotatably supported by the bushing 3722 in a state of being inserted into the circular hole of the bushing 3722 of the first bracket 372.

In one example, similar to the first bracket 372, the second bracket 373 serves to support the right portion of the blind panel 371 so as to be relatively movable and prevent the blind panel 371 from deviating rearwards.

Similar to the first bracket 372, at least one second protrusion 3731d protruding toward the left portion of the blind panel 371 may be disposed on the front surface 3731a of a bracket body 3731 of the second bracket 373 so as to support the right portion of the blind panel 371 in a relatively moveable manner, that is, to allow the spacing between the blind panel 371 and the second bracket 373 in the front-rear direction (the F-R direction) to vary.

As in the embodiment, when a total of four first protrusions 3711d are disposed on the rear surface of the blind panel 371, a total of four second protrusions 3731d may be disposed on the front surface 3731a of the bracket body 3731 of the second bracket 373 in correspondence thereto.

As described above, each second protrusion 3731d of the second bracket 373 may be a hollow rib so as to be telescopically connected to the first protrusion 3711d of the blind panel 371.

The hollow defined inside the second protrusion 3731d of the second bracket 373 may be continuously defined from a front end of the second protrusion 3731d of the second bracket 373 to a rear surface of the bracket body 3731 of the second bracket 373.

Like the first bracket 372, the second bracket 373 may be fastened to the handle frame 30d to be described later.

To be fastened to the handle frame 30d, the second bracket 373 may include a plurality of fastening bosses 3731c through which screw holes are defined along the front-rear direction.

Illustratively, the plurality of fastening bosses 3731c of the second bracket 373 may be provided as a pair close to an upper surface of the bracket body 3731 of the second bracket 373, and may be provided as a pair close to a lower surface of the bracket body 3731 of the second bracket 373.

In correspondence to the plurality of fastening bosses 3731c of the second bracket 373, two pairs of second screw bosses 30d6 arranged with the handle entrance 30d2 interposed therebetween may be integrally formed inside the handle frame 30d.

In addition, the second bracket 373 may also serve to rotatably support the second lead screw 352b.

To this end, the bushing 3732 may be integrally formed with a right end surface 3731b of the bracket body 3731 of the second bracket 373.

The bushing 3732 of the second bracket 373 may include a circular hole defined to pass therethrough along the left-right direction.

A right end of the second lead screw 352b may be rotatably supported by the bushing 3732 in a state of being inserted into the circular hole of the bushing 3732 of the second bracket 373.

In one example, the blind module 37 may further include a plurality of compression springs 374 disposed between the first bracket 372 and the blind panel 371 and disposed between the second bracket 373 and the blind panel 371.

The plurality of compression springs 374 serve to push the blind panel 371 frontwards such that the blind panel 371 moves in association with the forward and rearward reciprocating motion of the pop-up handle 31.

As such, a restoring force for the front end surface 3711a of the blind panel 371 to form a continuous surface with the front panel 30a may be provided through the plurality of compression springs 374. In this regard, because a rear side of the front panel 30a is pressurized by the plurality of compression springs 374, when the user presses the blind panel 371, it may be easily pressed rearwards. Accordingly, even when a user's finger or an external object is caught between the first handle body 311 and the blind panel 371, because the blind panel 371 may be easily pressed rearwards, a space for the finger or the object to escape may be easily secured, thereby improving safety.

When the blind panel 371 is supported so as to be relatively movable through the first bracket 372 and the second bracket 373, at least one compression spring 374 may be disposed between the first bracket 372 and the left portion of the blind panel 371 and between the second bracket 373 and the right portion of the blind panel 371.

In the illustrated embodiment, illustratively a configuration in which the compression springs 374 are equipped as coil springs disposed between the first bracket 372 and the blind panel 371 and between the second bracket 373 and the blind panel 371 in a compressed state is illustrated.

The present disclosure is not limited thereto, but a description will be made based on an embodiment in which the coil spring is equipped as the compression spring 374.

The compression spring 374 disposed between the first bracket 372 and the left portion of the blind panel 371 may be disposed such that the first protrusion 3711d of the blind panel 371 and the second protrusion 3721d of the first bracket 372 pass through a space defined inward thereof.

In this regard, a front end of the compression spring 374 is in contact with a rear surface of the left portion of the blind panel 371.

In addition, a rear end of the compression spring 374 is in contact with the front surface 3721a of the first bracket 372.

As the compression spring 374 is in contact with the rear surface of the left portion of the blind panel 371 and the front surface 3721a of the first bracket 372 in the compressed state as such, a state in which a restoring force of the compression spring 374 pushes the left portion of the blind panel 371 forward at all times may be formed.

In addition, the compression spring 374 disposed between the second bracket 373 and the right portion of the blind panel 371 may be disposed such that the first protrusion 3711d of the blind panel 371 and the second protrusion 3731d of the second bracket 373 pass through a space defined inward thereof.

In this regard, a front end of the compression spring 374 is in contact with a rear surface of the right portion of the blind panel 371.

In addition, a rear end of the compression spring 374 is in contact with the front surface 3731a of the second bracket 373.

As the compression spring 374 is in contact with the rear surface of the right portion of the blind panel 371 and the front surface 3731a of the second bracket 373 in the compressed state, a state in which a restoring force of the compression spring 374 pushes the left portion of the blind panel 371 forward at all times may be formed.

In the illustrated embodiment, a configuration in which one compression spring 374 is disposed between the first bracket 372 and the left portion of the blind panel 371 and one compression spring 374 is disposed between the second bracket 373 and the right portion of the blind panel 371 is illustrated.

The number of equipped compression springs 374 may increase depending on a size and a weight of the blind panel 371.

However, the number of compression springs 374 disposed between the first bracket 372 and the left portion of the blind panel 371 and the number of compression springs 374 disposed between the second bracket 373 and the right portion of the blind panel 371 may be set to be equal to each other such that the equal restoring forces may be applied to both sides of the blind panel 371.

In addition, for the same reason, a spring constant of the compression spring 374 disposed between the first bracket 372 and the left portion of the blind panel 371 and a spring constant of the compression spring 374 disposed between the second bracket 373 and the right portion of the blind panel 371 may be set to be equal to each other.

A detailed process in which the blind panel 371 moves in association with the movement of the pop-up handle 31 will be described later with reference to FIGS. 12 to 14D.

In one example, the dish washer 1 according to an embodiment of the present disclosure may include the handle frame 30d accommodating the handle driver 35 and the pop-up handle 31 therein.

More specifically, the handle frame 30d may include the frame body 30d1 accommodating the pop-up handle 31 and the handle driver 35 therein.

As shown in FIGS. 6 and 7, the frame body 30d1 may have a hollow box shape to entirely accommodate the pop-up handle 31 and the handle driver 35 therein and support them.

In this regard, the rear surface of the frame body 30d1 may be in an entirely open state such that the pop-up handle 31 and the handle driver 35 may be assembled from the rear.

In this regard, to prevent introduction of leaked water, an upper wall 30d12 constituting an upper surface of the frame body 30d1, a lower wall 30d13 constituting a lower surface, a left wall 30d14 constituting a left side surface, and a right wall 30d15 constituting a right side surface may be formed in a state of being generally blocked.

In one example, the handle entrance 30d2 having a cross-sectional area and a shape corresponding to the outer appearance of the pop-up handle 31 may be defined through the front wall 30d11 of the frame body 30d1 such that the pop-up handle 31 may enter and exit. Accordingly, the front wall 30d11 of the frame body 30d1 may be partially opened.

The handle entrance 30d2 may be defined directly at the rear of the opening 30e of the front panel 30a, and may have substantially the same shape as the opening 30e of the front panel 30a. However, as will be described later, the cross-sectional area of the handle entrance 30d2 may be slightly greater than a cross-sectional area of the opening 30e such that an opening flange 30e1 formed in the opening 30e of the front panel 30a may pass through the handle entrance 30d2.

To increase space utilization, a control panel holder 321 accommodating the above-described control panel 32 therein may be coupled to the upper wall 30d12 of the frame body 30d1 in a surface contact state.

In addition, for the same reason, the left wall 30d14 of the frame body 30d1 may be formed at a position as close as possible to a left side surface of the front panel 30a of the door 30, and the right wall 30d15 of the frame body 30d1 may be formed at a position as close as possible to a right side surface of the front panel 30a of the door 30.

In addition, the front wall 30d11 of the frame body 30d1 may be disposed in a state of being in close contact with the rear surface of the front panel 30a of the door 30 in a surface contact state.

Therefore, overall rigidity of the front panel 30a may be reinforced.

In particular, rigidity of the front panel 30a at a position where the rigidity may be significantly lowered because the opening 30e is defined may be reinforced by the frame body 30d1.

In one example, a substrate frame 30f that accommodates a driver control substrate 357 for controlling the handle driver 35 therein and supports the same may be disposed beneath the handle frame 30d.

As described above, the control panel holder 321 that accommodates the control panel 32 for controlling the operation of the dish washer 1 and a control panel substrate (not shown) therein may be coupled to the upper wall 30d12 of the frame body 30d1.

That is, as in the illustrated embodiment, the driver control substrate 357 for controlling the handle driver 35 may be disposed in the substrate frame 30f, separately from the control panel 32 and the control panel substrate (not shown).

However, unlike in the illustrated embodiment, the control substrates may be integrated to be a single control substrate capable of controlling both the operation of the dish washer 1 and the operation of the pop-up handle 31. Accordingly, the internal structure of the door 30 may be simplified.

Whether the control panel substrate and the driver control substrate 357 are separately equipped or integrated as described above, all of them may be electrically connected to a main controller (not shown) disposed in the main body of the dish washer 1. Accordingly, operation of various detailed components constituting the dish washer 1 including the pop-up handle 31 may be controlled by the main controller.

The substrate frame 30f may be separately formed and coupled to the handle frame 30d or may be integrally formed with the handle frame 30d.

FIG. 6 exemplarily shows that the substrate frame 30f is integrally connected to the handle frame 30d and is integrally formed therewith.

When the substrate frame 30f is integrally formed with the handle frame 30d, a separate fastening means for fixing the substrate frame 30f to the front panel 30a of the door 30 may be omitted.

The handle frame 30d and the substrate frame 30f may be directly fastened to the front panel 30a of the door 30 or indirectly fastened to the front panel 30a of the door 30.

A fixing bracket 30g may be disposed as a means for indirectly fastening the handle frame 30d to the front panel 30a of the door 30.

As illustrated in FIGS. 6 and 7, the fixing bracket 30g may extend in a shape at least partially surrounding a rear edge of the frame body 30d1 of the handle frame 30d.

As illustrated, the fixing bracket 30g may include multiple fastening holes through which a fastening means such as a screw bolt may pass.

Some of the multiple fastening holes serve to fasten the fixing bracket 30g to the front panel 30a of the door 30, and the remainder of the multiple fastening holes serve to fasten the fixing bracket 30g to the frame body 30d1 of the handle frame 30d.

Illustratively, a screw boss to which the screw bolt that has passed through the fastening hole of the fixing bracket 30d1 may be fastened may be integrally formed with the left wall 30d14, the right wall 30d15, and the lower wall 30d13 of the frame body 30g.

As described above, the handle frame 30d and the substrate frame 30f may be indirectly fastened to the front panel 30a of the door 30 through the fixing bracket 30g as such.

A means for directly fastening the handle frame 30d to the front panel 30a of the door 30 may be disposed on the entrance rib 30d3 of the frame body 30d1.

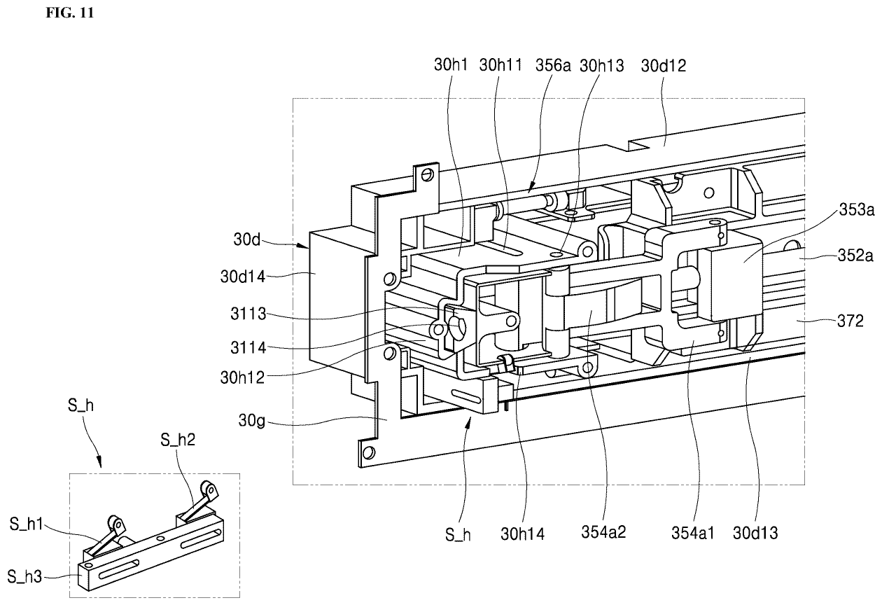

As illustrated in FIG. 11, the opening flange 30e1 extending rearwards may be disposed in the opening 30e of the front panel 30a of the door 30.

The opening flange 30e1 may be formed by partially bending the front panel 30a rearwards and plastically deforming the same.

The opening flange 30e1 may be integrally formed with a lower edge of the opening 30e and an upper edge of the opening 30e.

The opening flange 30e1 formed at the lower edge of the opening 30e may linearly extend along the lower edge of the opening 30e.

In addition, a width in the front-rear direction of the opening flange 30e1 formed at the lower edge of the opening 30e may be maintained substantially uniform as the opening flange extends along the lower edge of the opening 30e.

The opening flange 30e1 formed at the upper edge of the opening 30e may linearly extend along the upper edge of the opening 30e.

In addition, a width in the front-rear direction of the opening flange 30e1 formed at the upper edge of the opening 30e may be maintained substantially uniform as the opening flange 30e1 extends along the upper edge of the opening 30e.

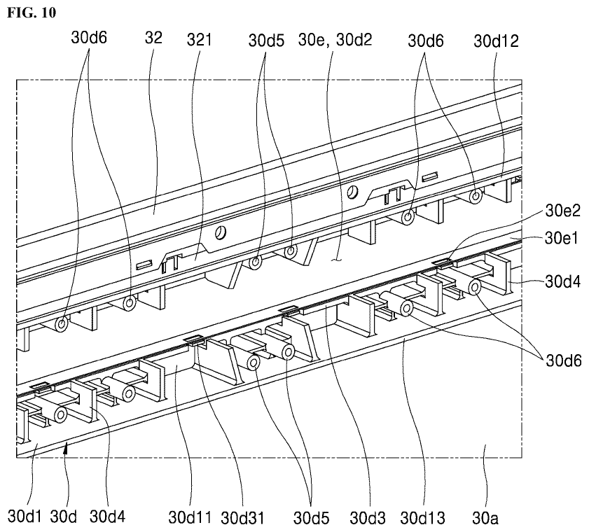

As illustrated in FIG. 10, the opening flange 30e1 may pass through the handle entrance 30d2 of the frame body 30d1 of the handle frame 30d and extend inwards of the frame body 30d1.

Similar to the opening flange 30e1 of the front panel 30a of the door 30, the handle entrance 30d2 of the handle frame 30d may be integrally formed with the entrance rib 30d3 extending inwards of the frame body 30d1.

The entrance rib 30d3 may be integrally formed with a lower edge of the handle entrance 30d2 and an upper edge of the handle entrance 30d2.

The entrance rib 30d3 formed at the lower edge of the handle entrance 30d2 may extend linearly along the lower edge of the handle entrance 30d2.

In addition, a width in the front-rear direction of the entrance rib 30d3 formed at the lower edge of the handle entrance 30d2 may be maintained substantially uniform as the entrance rib 30d3 extends along the lower edge of the handle entrance 30d2.

The entrance rib 30d3 formed at the upper edge of the handle entrance 30d2 may extend linearly along the upper edge of the handle entrance 30d2.

In addition, a width in the front-rear direction of the entrance rib 30d3 formed at the upper edge of the handle entrance 30d2 may be maintained to be substantially uniform as the entrance rib 30d3 extends along the upper edge of the handle entrance 30d2.

The width in the front-rear direction of the entrance rib 30d3 formed at the handle entrance 30d2 may be set to be equal to or greater than the width in the front-rear direction of the opening flange 30e1 formed at the opening 30e of the door 30.

In this regard, as illustrated, a plurality of hook holes 30e2 may be defined to extend vertically through the opening flange 30e1 formed at the opening 30e of the door 30.

A plurality of hooks 30d31 detachably coupled to the individual hook holes 30e2 may be integrally formed with the entrance rib 30d3 at positions corresponding to positions of the individual hook holes 30e2.

The individual hook 30d31 may be integrally formed with the entrance rib 30d3 by partially cutting the entrance rib 30d3.

As the individual hooks 30d31 are inserted into and coupled to the individual hook holes 30e2 corresponding thereto as such, the plurality of hooks 30d31 and the plurality of hook holes 30e2 function as means for directly fastening the handle frame 30d with the front panel 30a of the door 30.

Furthermore, the opening flange 30e1 of the door 30 and the entrance rib 30d3 of the handle frame 30d are configured to be coupled to each other in a surface contact state.

Because of such surface-contact coupling, the opening flange 30e1 of the door 30 and the entrance rib 30d3 of the handle frame 30d may mutually reinforce each other in terms of rigidity.

In one example, as shown in FIG. 10, multiple reinforcing ribs 30d4 may be integrally formed with the inside of the frame body 30d1 of the handle frame 30d.

As described above, the frame body 30d1 of the handle frame 30d is formed in the hollow box shape.

In addition, the rear surface of the frame body 30d1 is entirely open, and the handle entrance 30d2 corresponding to the outer appearance of the pop-up handle 31 is defined through the front wall 30d11 of the frame body 30d1.

Therefore, the multiple reinforcing ribs 30d4 may be integrally formed for the purpose of preventing deterioration of rigidity of the frame body 30d1 resulted from the entire opening of the rear surface and the partial opening of the front wall 30d11.

In consideration of the entire opening of the rear surface and the partial opening of the front wall 30d11, the plurality of reinforcing ribs 30d4 may be arranged in a manner of being divided in the vertical direction based on the handle entrance 30d2.

The reinforcing ribs 30d4 arranged above the handle entrance 30d2 may be integrally connected to the front wall 30d11 and the upper wall 30d12 of the frame body 30d1.

The reinforcing ribs 30d4 arranged below the handle entrance 30d2 may be integrally connected to the front wall 30d11 and the lower wall 30d13 of the frame body 30d1.

In addition, each reinforcing rib 30d4 may extend linearly in the front-rear direction.

In this regard, lengths of the respective reinforcing ribs 30d4 extending from the front wall 30d11 of the frame body 30d1 may be different from each other depending on positions thereof.

However, a thickness of each reinforcing rib 30d4 may be maintained to be substantially uniform as the reinforcing rib 30d4 extends along the front-rear direction (the F-R direction).

This is to configure each of the reinforcing ribs 30d4 to be inserted into the slit 3712a defined in the flange 3712 of the blind panel 371, as described above, so that the slit 3712a of the flange 3712 of the blind panel 371 and the reinforcing rib 30d4 of the handle frame 30d may act as guide means for guiding the forward and rearward reciprocating motion of the blind panel 371.

In one example, as illustrated, the first screw boss 30d5 and the second screw boss 30d6 may be disposed between respective pairs of adjacent reinforcing ribs 30d4, respectively.

As described above, the first screw boss 30d5 has the purpose of fixing the motor bracket 3511a using the screw bolt.

In addition, as described above, the second screw boss 30d6 has the purpose of fixing the first bracket 372 and the second bracket 373 of the blind module 37 using the screw bolt.

In this regard, additional ribs extending along the left-right direction may be disposed between the first screw boss 30d5 and its adjacent reinforcing rib 30d4, and between the second screw boss 30d6 and its adjacent reinforcing rib 30d4, so as to integrally connect them. Accordingly, connection strength and rigidity between the first screw boss 30d5, the second screw boss 30d6, and the reinforcing rib 30d4 may be additionally secured.

In one example, the handle frame 30d may also serve to guide the forward and rearward reciprocating motion of the pop-up handle 31.

That is, as described above, the pop-up handle 31 may be configured to horizontally move along a forward direction Dfw or a rearward direction Drw by the forward driving force or the reverse driving force of the handle driver 35.

A means for implementing such horizontal movement may be disposed on the pop-up handle 31 and the handle frame 30d in which the pop-up handle 31 is accommodated.

As a means for implementing the horizontal movement, the pop-up handle 31 may include a pair of guide blocks 3114.

As described above, one of the pair of guide blocks 3114 may be fixed to the left side surface of the second handle body 3112.

In addition, the other of the pair of guide blocks 3114 may be fixed to the right side surface of the third handle body 3113.

In this regard, thicknesses of the pair of guide blocks 3114 in the left-right direction (the Le-Ri direction) may be maintained uniform as the guide blocks 3114 extend along the front-rear direction (the F-R direction).

In addition, heights of the pair of guide blocks 3114 in the vertical direction (the U-D direction) may be maintained uniform as the guide blocks 3114 extend along the front-rear direction (the F-R direction).

In one example, as the means for implementing the horizontal movement, the handle frame 30d may include the guide bracket 30h1 and 30h2.

The guide bracket 30h1 and 30h2 serves to accommodate the second handle body 3112 and the third handle body 3113 of the pop-up handle 31 therein and guide the forward and rearward horizontal movement of the second handle body 3112 and the third handle body 3113.

Illustratively, the guide bracket 30h1 and 30h2 may include the first guide bracket 30h1 accommodating the second handle body 3112 therein and the second guide bracket 30h2 accommodating the third handle body 3113 therein.

The first guide bracket 30h1 and the second guide bracket 30h2 may be integrally formed with the frame body 30d1 of the handle frame 30d.

In addition, the first guide bracket 30h1 and the second guide bracket 30h2 may be formed separately from the frame body 30d1 and fastened to the frame body 30d1.

In the illustrated embodiment, a configuration in which the first guide bracket 30h1 and the second guide bracket 30h2 are separately formed and fastened to the frame body 30d1 is illustrated. The present disclosure is not limited thereto, but a description will be made based on the illustrated embodiment.

First, as shown in FIG. 11, the first guide bracket 30h1 may be formed in a hollow box shape such that the second handle body 3112 may be movably accommodated therein.

In this regard, a front surface and a rear surface of the first guide bracket 30h1 may be entirely open so as to ensure the horizontal movement of the second handle body 3112 in the front-rear direction (the F-R direction).

In addition, to prevent interference with the first driving link 354a1 and the first driven link 354a2 constituting the handle driver 35, a right side surface of the first guide bracket 30h1 may be entirely opened.

In this regard, a block guide groove 30h12 formed to be convex leftwards (a Le-direction) may be formed at a left side surface of the first guide bracket 30h1.

The guide block 3114 attached to the second handle body 3112 may be inserted into the block guide groove 30h12.

The block guide groove 30h12 may have a cross-sectional shape corresponding to an outer appearance of the guide block 3114 attached to the second handle body 3112.

In addition, the block guide groove 30h12 may linearly extend along the front-rear direction (the F-R direction).

Therefore, as the second handle body 3112 moves in a state in which the guide block 3114 is inserted into the block guide groove 30h12, the horizontal movement of the second handle body 3112 in the front-rear direction (the F-R direction) may be guided.

In addition, as described above, the pin guide slit 30h11 extending linearly along the front-rear direction (the F-R direction) may be vertically defined through the upper surface and the lower surface of the first guide block 3114.

An upper end of the second moving pin Pm2 is inserted into and coupled to the pin guide slit 30h11 defined in the upper surface of the first guide block 3114.

In addition, the upper end of the second moving pin Pm2 is inserted into and coupled to the pin guide slit 30h11 defined in the lower surface of the first guide block 3114.

As described above, the other end of the first driving link 354a1 is connected, in a relatively rotatable manner, to the second handle body 3112 by the second moving pin Pm2.

Because the movement is guided in a state in which the second moving pin Pm2 is inserted into the pin guide slit 30h11, the second handle body 3112 and the other end of the first driving link 354a1 may be guided in a movement direction such that they horizontally move along the front-rear direction (the F-R direction) along the pin guide slit 30h11.

In one example, the pin holes 30h13 into which the fixing pins Pf for connecting the other end of the first driven link 354a2 to the first guide bracket 30h1 in a relatively rotatable manner are inserted and coupled may be defined to vertically (the U-D direction) extend through the upper surface and the lower surface of the first guide bracket 30h1, respectively.

In one example at least one sensor hole 30h14 may be defined through the lower surface of the first guide bracket 30h1 in the vertical direction (the U-D direction).

As illustrated in FIG. 11, the dish washer 1 according to an embodiment of the present disclosure may include a handle position sensor module S_h as a means for sensing the position of the pop-up handle 31.

In the embodiment, a configuration in which the handle position sensor module S_h includes a first switch S_h1 and a second switch S_h2 that output ON-OFF signals is illustrated as an example.

When the handle position sensor module S_h is composed of the first switch S_h1 and the second switch S_h2 as described above, the first switch S_h1 and the second switch S_h2 may be arranged in a line along the front-rear direction (the F-R direction).

Illustratively, the first switch S_h1 may be disposed in the front, and the second switch S_h2 may be disposed in the rear.

In this regard, a lever of the first switch S_h1 and a lever of the second switch S_h2 may pass through the sensor holes 30h14 and extend inwards, respectively.

Therefore, as illustrated, when the second handle body 3112 is located at the retracted position Pa, the lever of the first switch S_h1 and the lever of the second switch S_h2 are pressed by the lower surface of the second handle body 3112.

Accordingly, when the second handle body 3112 is located at the retracted position Pa, both the first switch S_h1 and the second switch S_h2 output the ON signals.

In addition, when the second handle body 3112 starts to move from the retracted position Pa toward the extended position Pd, the output signal of the second switch S_h2 may be converted into the OFF signal.

In addition, when the movement of the second handle body 3112 to the extended position Pd is completed, the output signal of the first switch S_h1 may be converted into the OFF signal.

By detecting that the output signals of the first switch S_h1 and the second switch S_h2 are converted from the ON signals to the OFF signals, respectively, a current position of the second handle body 3112 and whether the second handle body 3112 is moving may be effectively and easily detected.

In one example, the first switch S_h1 and the second switch S_h2 may be disposed between the lower wall 30d13 of the frame body 30d1 and the lower surface of the first guide bracket 30h1 in a state in which they are collectively fastened to and supported by a sensor holder S_h3.

In one example, the second guide bracket 30h2 may be disposed at a position symmetrical to that of the first guide bracket 30h1 with respect to the vertical surface that equally divides the pop-up handle 31 along the horizontal direction so as to movably accommodate the third handle body 3113 therein.

In addition, for the same reason, the second guide bracket 30h2 may have a shape symmetrical to that of the first guide bracket 30h1 with respect to the vertical surface that equally divides the pop-up handle 31 along the horizontal direction.

Because the second guide bracket 30h2 has the shape and the position symmetrical to those of the first guide bracket 30a, a description of redundant contents regarding the second guide bracket 30a will be omitted below.

### Movement of Pop-Up Handle and Action of Blind Module Based on Operation of Handle Driver

Hereinafter, referring to FIGS. 12 to 14D, a process in which the pop-up handle 31 moves forward from the retracted position Pa to the extended position Pd based on the operation of the handle driver 35 and a process in which the opening 30e and the handle entrance 30d2 are covered by the blind module in association with the movement of the pop-up handle 31 will be described.

First, FIG. 12 shows a state in which the pop-up handle 31 is stopped at the retracted position Pa.

When power is supplied to the driving motor 351 from the state illustrated in FIG. 12, the forward movement of the pop-up handle 31 may be started from the retracted position Pa toward the extended position Pd.

Referring to FIG. 10, when the power is supplied to the driving motor 351 in a state in which the pop-up handle 31 is moved to the retracted position Pa and stopped, the operation of the driving motor 351 is started, and the driving motor 351 generates the forward rotational driving force.

Accordingly, the forward rotations of the first output shaft 3512a and the second output shaft 3512b of the driving motor 351 may be started.

In this regard, when the forward rotations of the first output shaft 3512a and the second output shaft 3512b are started, a leftward linear movement of the first nut 353a screwed to the first output shaft 3512a is started, and a rightward linear movement of the second nut 353b screwed to the second output shaft 3512b is started.

As the leftward linear movement of the first nut 353a is started, one end of the first driving link 354a connected to the first nut 353a1 in a relatively rotatable manner through the first moving pin Pm1 is moved leftward.

In addition, as the rightward linear movement of the second nut 353b is started, one end of the second driving link 354b connected to the second nut 353b1 in a relatively rotatable manner through the first moving pin Pm1 is moved rightward.

In this regard, the first driving link 354a1 is connected to one end of the first driven link 354a2 through the third moving pin Pm3 at an intermediate position.

In addition, the second driving link 354b1 is connected to one end of the second driven link 354b2 through the third moving pin Pm3 at an intermediate position.

Therefore, based on the state illustrated in FIG. 12, the first driving link 354a1 entirely rotates around the third moving pin Pm3 in a clockwise direction.

In addition, the second driving link 354b1 entirely rotates around the third moving pin Pm3 in a counterclockwise direction.

As the first driving link 354a1 rotates clockwise around the third moving pin Pm3, the other end of the first driving link 354a1 rotates to be directed forward.

In addition, as the second driving link 354b1 rotates counterclockwise around the third moving pin Pm3, the other end of the second driving link 354b1 rotates to be directed forward.

Because the other end of the first driving link 354a1 is connected to the second handle body 3112 so as to be relatively rotatable through the second moving pin Pm2, the rotational force transmitted through the other end of the first driving link 354a1 may be transmitted to the second handle body 3112 through the second moving pin Pm2.

In addition, because the other end of the second driving link 354b1 is connected to the third handle body 3113 so as to be relatively rotatable around the second moving pin Pm2, the rotational force transmitted through the other end of the second driving link 354b1 may be transmitted to the third handle body 3113 through the second moving pin Pm2.

Accordingly, the second handle body 3112 and the third handle body 3113 may start to move forward toward the extended position Pd, respectively.

When the first nut 353a and the second nut 353b have moved to predetermined positions after the operation of the handle driver 35 is started, the supply of power to the driving motor 351 may be stopped and the forward movement of the pop-up handle 31 to the extended position Pd may be completed.

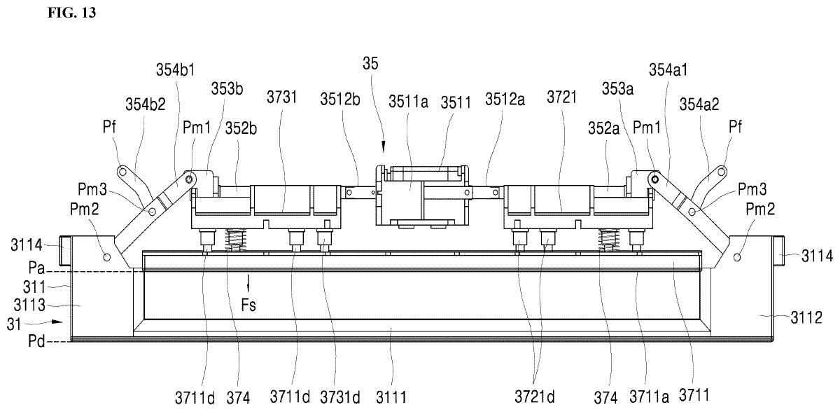

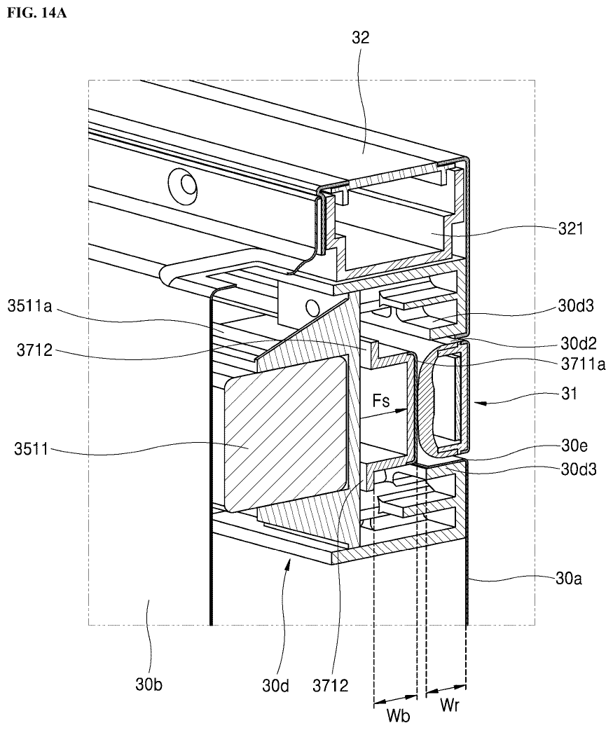

FIG. 13 illustrates a state in which the pop-up handle 31 is stopped after the forward movement to the extended position Pd is completed.

When the forward movement of the pop-up handle 31 to the extended position Pd is completed as described above, the first handle body 311 may be entirely exposed to the outside of the door 30, and the user may easily perform the operation of opening the door 30 or closing the door 30 while gripping the first handle body 311.

As illustrated in FIG. 12, the blind panel 371 that moves forward or rearward in association with the movement of the first handle body 311 may be disposed at the rear of the first handle body 311.

As described above, when the pop-up handle 31 is moved to the retracted position Pa, the opening 30e of the door 30 is entirely closed by the first handle body 311, the second handle body 3112, and the third handle body 3113.

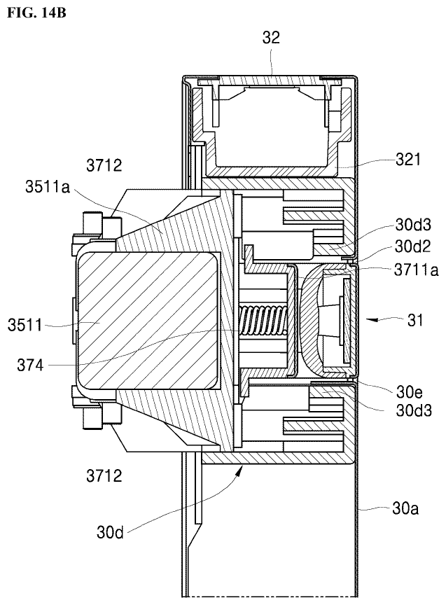

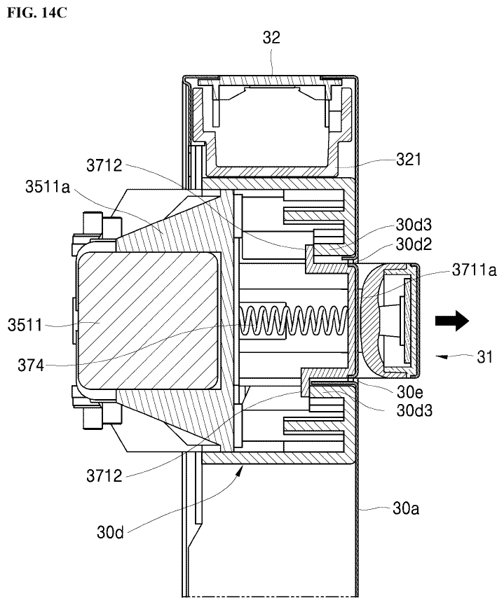

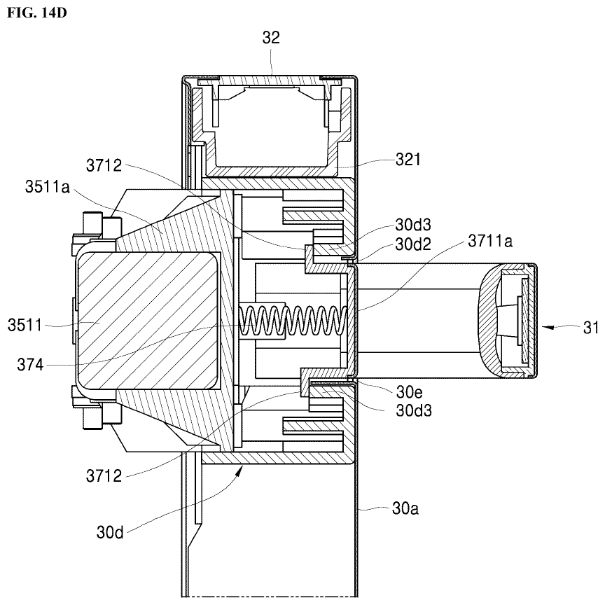

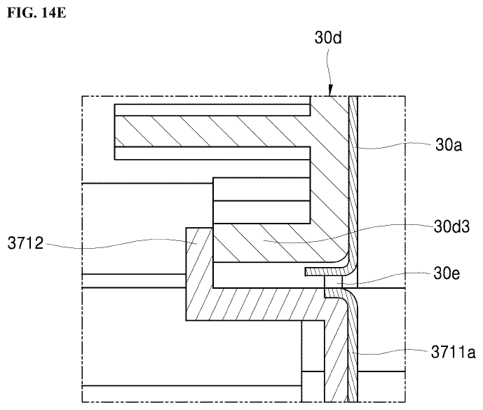

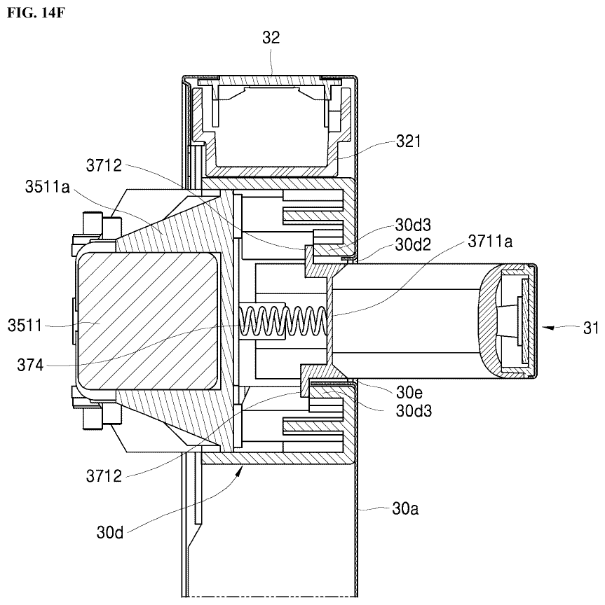

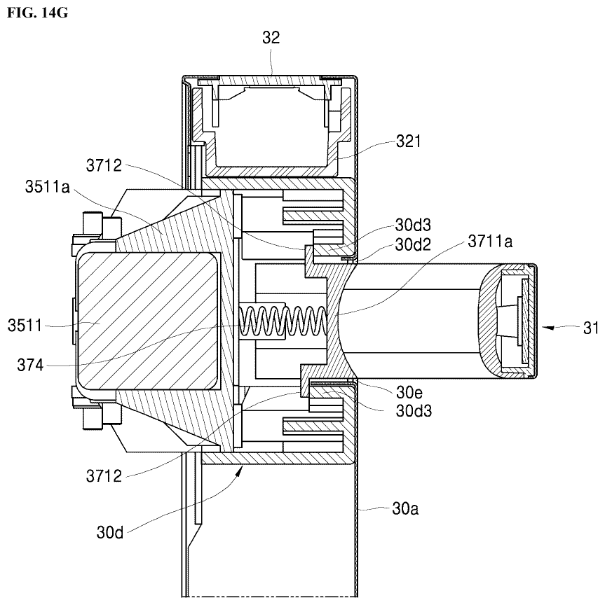

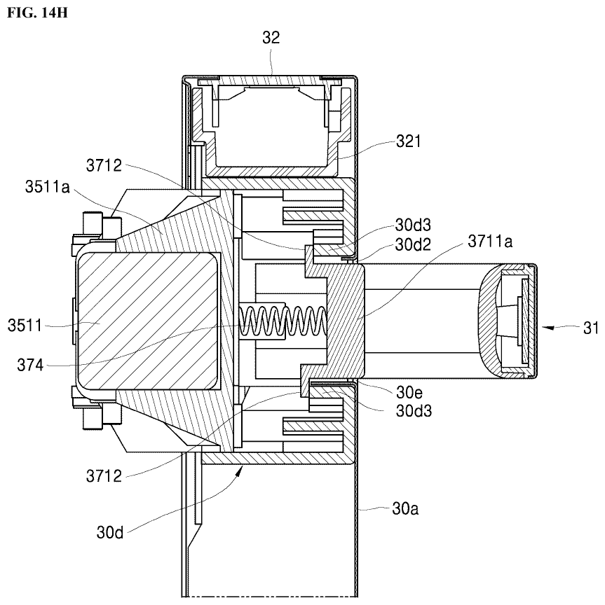

In this regard, as shown in FIGS. 14A and 14B, when the pop-up handle 31 is moved to the retracted position Pa, the blind panel 371 may be pressed by the first handle body 311, horizontally moved to the most rearward position, and stopped.

When the blind panel 371 stops at the most rearward position, the compression springs 374 disposed between the blind panel 371 and the first bracket 372 and between the blind panel 371 and the second bracket 373, respectively, are maximally compressed, and maximum restoring forces of the compression springs 374 act on the rear surface of the blind panel 371.

Accordingly, the front end surface 3711a of the blind panel 371 may be maintained in a state of being in close contact with the first handle body 311 by the maximum restoring forces of the compression springs 374.

In one example, when the forward movement of the pop-up handle 31 from the retracted position Pa toward the extended position Pd is started, the restoring forces of the compression springs 374 may act to cause the blind panel 371 to start the forward horizontal movement from the most rearward position together with the first handle body 311.

After the forward movement of the pop-up handle 31 from the retracted position Pa toward the extended position Pd is started, the blind panel 371 moves together with the pop-up handle 31 by the restoring forces of the compression springs 374 until the first handle body 311 passes through the opening 30e of the door 30 and the handle entrance 30d2 of the handle frame 30d and is completely out of the opening 30e of the door 30 and the handle entrance 30d2 of the handle frame 30d.

As shown in FIGS. 14C and 14D, when the pop-up handle 31 is additionally moved, the first handle body 311 passes through the opening 30e of the door 30 and the handle entrance 30d2 of the handle frame 30d, and passes through a position at which it is entirely out of the opening 30e of the door 30 and the handle entrance 30d2 of the handle frame 30d.

In this regard, when the first handle body 311 passes through the opening 30e of the door 30 and the handle entrance 30d2 of the handle frame 30d and passes through passes through the position at which it is entirely out of the opening 30e of the door 30 and the handle entrance 30d2 of the handle frame 30d, the blind panel 371 may be moved to the most forward position and stopped at the most forward position.

That is, when the panel body 3711 moves to the most forward position, the flange 3712 integrally formed with the blind panel 371 may come into contact with and collide with a rear edge of the entrance rib 30d3 of the handle frame 30d, and thus the panel body 3711 may be stopped at the most forward position.

As described above, the front end surface 3711a of the blind panel 371 may be separated from the first handle body 311 while the state in which it is in close contact with the first handle body 311 is released at the most forward position of the panel body 3711.

In addition, when the panel body 3711 is stopped at the most forward position, the compression springs 374 disposed between the blind panel 371 and the first bracket 372 and between the blind panel 371 and the second bracket 373, respectively, are in a state of being compressed to a minimum, and thus minimum restoring forces of the compression springs 374 act on the rear surface of the blind panel 371.

That is, when the pop-up handle 31 is initially driven from the retracted position Pa toward the extended position Pd, a driving load is greatest on the driving motor 351.

In this regard, the compression springs 374 may assist in pushing the pop-up handle 31 toward the extended position Pd. That is, the pressing force of the compression springs 374 may be transmitted to the pop-up handle 31 until the states shown in FIGS. 14B and 14C. In the state shown in FIG. 14D, the pop-up handle 31 moves toward the extended position Pd solely by the driving force of the driving motor 351.

As described above, when the blind panel 371 is moved to the most forward position, the opening 30e of the front panel 30a and the handle entrance 30d2 of the handle frame 30d are covered by the blind panel 371.

However, the opening 30e of the front panel 30a and the handle entrance 30d2 of the handle frame 30d are not completely covered by the blind panel 371.

More specifically, as shown in FIG. 14E, a vertical gap may be formed between the entrance rib 30d3 of the handle frame 30d and the blind panel 371.

In this regard, as illustrated, a bent portion of the front panel 30a of the door 30 is inserted into the handle entrance 30d2 of the handle frame 30d.

Therefore, to minimize interference with the bent portion of the front panel 30a, the vertical gap may be formed to have a width greater than a thickness of the front panel 30a.

As the vertical gap is formed to the extent that the bent portion of the front panel 30a may be inserted into the vertical gap, friction may be minimized when the pop-up handle 31 and the blind panel 371 are moved, and a sense of unity may be formed between the front panel 30a and the front end surface 3711a of the blind panel 371 when observed from the outside.

In addition, as shown in FIG. 14E, when the blind panel 371 is moved to the most forward position, the front end surface 3711a of the blind panel 371 may be stopped while forming a continuous surface with the front surface of the front panel 30a of the door 30.

At this time, a state in which no step is formed between the front panel 30a of the door 30 and the front end surface 3711a of the blind panel 371 may be formed.

However, alternatively, a shape of the front end surface 3711a of the blind panel 371 may be determined such that the front panel 30a of the door 30 and the front end surface 3711a of the blind panel 371 form the continuous surface, but the step is formed between the front panel 30a of the door 30 and the front end surface 3711a of the blind panel 371.

More specifically, as shown in FIGS. 14F and 14G, the front end surface 3711a of the blind panel 371 may be formed to have a concave surface that is recessed rearwards from the front panel 30a.

For example, as shown in FIG. 14F, the front end surface 3711a of the blind panel 371 may be formed as a concave surface including an inclined surface and a vertical surface.

Furthermore, as shown in FIG. 14G, for example, the front end surface 3711a of the blind panel 371 may be formed as a concave surface including a curved surface having a predetermined curvature.

As the front end surface 3711a of the blind panel 371 is recessed rearwards relative to the front panel 30a, a through area of the pop-up handle 31 defined at the rear of the first handle body 311 after the pop-up handle 31 is moved to the extended position Pd may be additionally secured.

Accordingly, a gripping space for the user may be additionally secured, thereby improving user convenience and stability.

Alternatively, when the blind panel 371 is moved to the most forward position, as shown in FIG. 14H, it may be stopped at a position protruding by a predetermined amount from the front surface of the front panel 30a of the door 30.

Also in this case, a corner where the front end surface 3711a of the blind panel 371 is connected to the front panel 30a may be formed with a chamfered surface in a shape of a curved or inclined surface. Accordingly, a sense of unity or connection may be maintained between the front end surface 3711a of the blind panel 371 and the front panel 30a.

To this end, as illustrated in FIG. 14A, a width Wb in the front-rear direction (the F-R direction) between the front end surface 3711a and the flange 3712 of the blind panel 371 may be set to be slightly greater than or equal to a width Wr in the front-rear direction (the F-R direction) of the entrance rib 30d3.

### Detailed Configuration and Action of Positional Deviation Adjustor

Hereinafter, a detailed configuration and an action of the positional deviation adjustor 356a and 356b disposed in the dish washer 1 according to an embodiment of the present disclosure will be described with reference to FIGS. 15 to 17.

As described above, in the present disclosure, the rotational driving force for the forward and rearward reciprocating motion of the pop-up handle 31 is generated through the single driving motor 351.

Accordingly, there is a high possibility that the positional deviation between the second handle body 3112 and the third handle body 3113 may occur in the forward and rearward reciprocating motion process of the pop-up handle 31.

The positional deviation adjustor 356a and 356b serve to minimize the positional deviation between the second handle body 3112 and the third handle body 3113.

In more detail, as illustrated, the positional deviation adjustor 356a and 356b may include the first deviation adjustor 356a that adjusts the position of the second handle body 3112 in the front-rear direction (the F-R direction).

In addition, the positional deviation adjustor 356a and 356b may include the second deviation adjustor 356b that adjusts the position of the third handle body 3113 in the front-rear direction (the F-R direction).

Illustratively, the first deviation adjustor 356a may include a first-first shaft 356a1 having one end connected to the second handle body 3112 in a relatively rotatable manner.

In addition, the first deviation adjustor 356a may include a first-second shaft 356a2 having one end connected to the handle frame 30d in a relatively rotatable manner.

In addition, the first deviation adjustor 356a may include a first spring 356a3 that applies a restoring force such that a spacing between the one end of the first-first shaft 356a1 and the one end of the first-second shaft 356a2 is increased.

The first-first shaft 356a1 and the first-second shaft 356a2 may be connected to each other in a telescopic manner.

To be connected in the telescopic manner, the first-first shaft 356a1 may be a hollow shaft, and the first-second shaft 356a2 into which the first-first shaft 356a1 is coupled and inserted may be a hollow rib.

The first spring 356a3 may be disposed in a compressed state inside the first-first shaft 356a1.

In this regard, the one end of the first-first shaft 356a1 may be connected to the second handle body 3112 so as to be relatively rotatable through a moving pin.

More specifically, the one end of the first-first shaft 356a1 may be connected to the upper end of the second moving pin Pm2 described above so as to be relatively rotatable together with the first driving link 354a1.

Accordingly, the one end of the first-first shaft 356a1 may move along the front-rear direction (the F-R direction) together with the second moving pin Pm2 when the second handle body 3112 moves.

To this end, a ring having a circular hole defined therein into which the second moving pin Pm2 is inserted may be disposed at the one end of the first-first shaft 356a1.

In addition, the one end of the first-second shaft 356a2 may be connected to the upper wall 30d12 of the handle frame 30d so as to be relatively rotatable through a fixing pin Pf (not shown).

Therefore, the one end of the first-second shaft 356a2 may be in a state in which only the relative rotation is available.

In this regard, when the pop-up handle 31 is stopped at the retracted position Pa, the one end of the first-first shaft 356a1 is disposed rearward of the one end of the first-second shaft 356a2 in the front-rear direction (the F-R direction).

Therefore, when the pop-up handle 31 is stopped at the retracted position Pa, the first deviation adjustor 356a applies a force to push the second handle body 3112 rearwards to the second handle body 3112.

In one example, the second deviation adjustor 356b may be disposed at a position symmetrical to a position of the first deviation adjustor 356a with respect to the vertical surface that equally divides the pop-up handle 31 along the horizontal direction and formed in a shape symmetrical to a shape thereof.

Accordingly, similar to the first deviation adjustor 356a, the second deviation adjustor 356b may include a second-first shaft 356b1 and a second-second shaft 356b2 connected to each other in a telescopic manner, and a second spring 356b3 may be disposed in a compressed state inside the second-first shaft 356b1.

In addition, one end of the second-first shaft 356b1 may be connected to the upper end of the second moving pin Pm2 described above so as to be relatively rotatable together with the second driving link 354b1.

Accordingly, the one end of the second-first shaft 356b1 may move along the front-rear direction (the F-R direction) together with the second moving pin Pm2 when the third handle body 3113 moves.

To this end, a ring having a circular hole into which the second moving pin Pm2 is inserted may be disposed at the one end of the second-first shaft 356b1.

In addition, one end of the second-second shaft 356b2 may be connected to the upper wall 30d12 of the handle frame 30d so as to be relatively rotatable through a fixing pin Pf (not shown).

Therefore, the one end of the second-second shaft 356b2 may be in a state in which only the relative rotation is available.

In this regard, in the same manner as the first deviation adjustor 356a, when the pop-up handle 31 is stopped at the retracted position Pa, the one end of the second-first shaft 356b1 is disposed rearward of the one end of the second-second shaft 356b2 in the front-rear direction (the F-R direction).

Therefore, when the pop-up handle 31 is stopped at the retracted position Pa, the second deviation adjustor 356b applies a force to push the third handle body 3113 rearwards to the second handle body 3112.

However, the one end of the first-first shaft 356a1 of the first deviation adjustor 356a is movable along the front-rear direction (the F-R direction) together with the second handle body 3112, but the one end of the first-second shaft 356a2 of the first deviation adjustor 356a is not movable along the front-rear direction (the F-R direction).

Similarly, the one end of the second-first shaft 356b1 of the second deviation adjustor 356b is movable along the front-rear direction (the F-R direction) together with the third handle body 3113, but the one end of the second-second shaft 356b2 of the second deviation adjustor 356b is not movable along the front-rear direction (the F-R direction).

Accordingly, a direction of the force applied by the first deviation adjustor 356a and a direction of the force applied by the second deviation adjustor 356b may vary depending on the position of the second handle body 3112 in the front-rear direction (the F-R direction) and the position of the third handle body 3113 in the front-rear direction (the F-R direction).

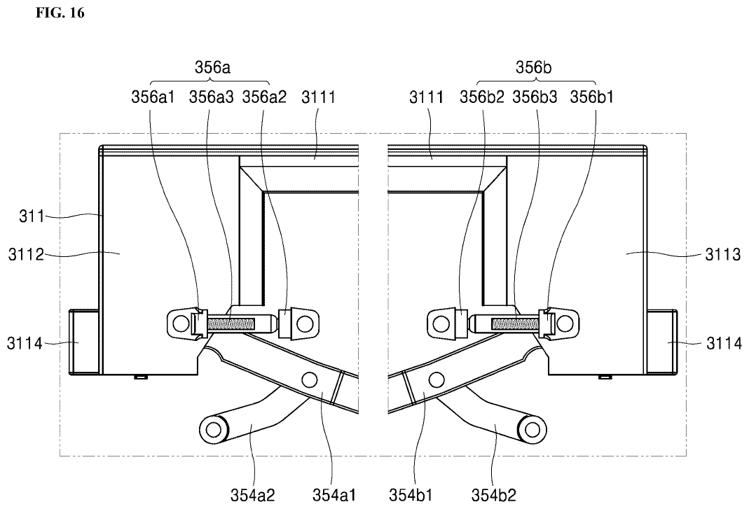

More specifically, a movement range of the pop-up handle 31 may include a first movement range defined between the retracted position Pa illustrated in FIGS. 15 and 16 and an intermediate position at which the first deviation adjustor 356a and the second deviation adjustor 356b are arranged parallel to the extension direction of the first handle body 311.

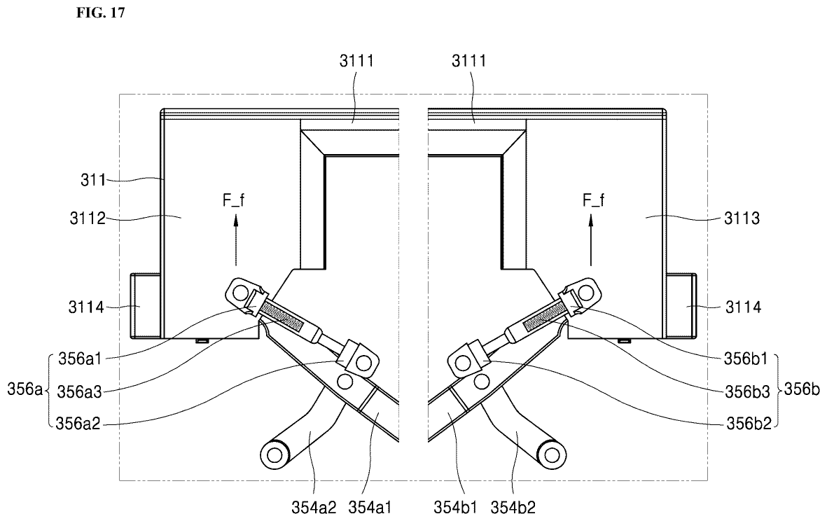

In addition, the movement range of the pop-up handle 31 may include a second movement range defined between the intermediate position at which the first deviation adjustor 356a and the second deviation adjustor 356b illustrated in FIGS. 16 and 17 are arranged parallel to the extension direction of the first handle body 311 and the extended position Pd.

When the position of the pop-up handle 31 is within the first movement range, the first deviation adjustor 356a applies a rearward pushing force F_r to the second handle body 3112, and the second deviation adjustor 356b applies a rearward pushing force F_r to the third handle body 3113.

Therefore, when the positional deviation occurs between the second handle body 3112 and the third handle body 3113 within the first movement range, a greater force is applied to one of the second handle body 3112 and the third handle body 3113, which has been moved further forwards, through the first deviation adjustor 356a and the second deviation adjustor 356b.

Accordingly, the positional deviation between the second handle body 3112 and the third handle body 3113 may be effectively adjusted within the first movement range.

In this regard, when the pop-up handle 31 passes the above-described intermediate position and moves to be within the second movement range, the force of the first deviation adjustor 356a and the force of the second deviation adjustor 356b are converted from the rearward pushing forces into frontward pushing forces.

Accordingly, when the position of the pop-up handle 31 is within the second movement range, the first deviation adjustor 356a applies a frontward pushing force F_f to the second handle body 3112, and the second deviation adjustor 356b applies a frontward pushing force F_f to the third handle body 3113.

As a result, when the positional deviation occurs between the second handle body 3112 and the third handle body 3113 within the second movement range, a greater force is applied to one of the second handle body 3112 and the third handle body 3113, which has been less moved frontwards, through the first deviation adjustor 356a and the second deviation adjustor 356b.

Accordingly, the positional deviation between the second handle body 3112 and the third handle body 3113 may be effectively adjusted within the first movement range.

Although the description has been made as above with reference to the illustrated drawings for the present disclosure, the present disclosure is not limited by the embodiments disclosed herein and the drawings, and it is obvious that various modifications may be made by a person skilled in the art within the scope of the technical idea of the present disclosure. In addition, even when effects according to the configuration of the present disclosure are not explicitly described and illustrated while describing the embodiments of the present disclosure, it is natural that effects predictable by the corresponding configuration should also be recognized.

What is claimed is:

1. A dish washer comprising:
a tub defining therein a washing space having an open front surface;
a door configured to open and close the open front surface of the tub;
a handle configured to move back and forth between an extended position where the handle protrudes frontwards from the door and a retracted position where the handle is at least partially accommodated in the door;
a handle driver disposed inside the door and configured to move the handle from the retracted position toward the extended position or from the extended position toward the retracted position; and
a blind module configured to cover an opening defined through the door to allow the handle to pass therethrough when the handle has moved to the extended position,
wherein the blind module is configured to cover the opening while moving frontwards in association with a movement of the handle.

2. The dish washer of claim 1, wherein the blind module includes:
a blind panel configured to cover the opening while moving between a most rearward position and a most forward position in association with the movement of the handle;
a bracket positioned at the rear of the blind panel; and
a spring disposed between the bracket and the blind panel, wherein the spring is configured to exert a restoring force on the blind panel in a direction where the blind panel becomes away from the bracket.

3. The dish washer of claim 2, wherein the handle includes:
a first handle body extending along a left-right direction from one end to a remaining end thereof; and
a second handle body and a third handle body respectively coupled to the one end and the remaining end of the first handle body and extending rearwards from the first handle body,
wherein when the handle has moved to the retracted position,
the opening is entirely closed by the first handle body, the second handle body, and the third handle body, and
the blind panel is pressed by the first handle body and moves to the most rearward position.

4. The dish washer of claim 3, wherein when the above blind panel has moved to the most rearward position, the spring is in a state of being maximally compressed.

5. The dish washer of claim 3, wherein when the blind panel has moved to the most rearward position, the blind panel remains in close contact with the first handle body.

6. The dish washer of claim 3, wherein when the handle starts to move from the retracted position toward the extended position, the blind panel moves frontwards together with the first handle body from the most rearward position because of the restoring force of the spring.

7. The dish washer of claim 3, wherein when the first handle body passes through the opening and protrudes entirely outwards from the door after the handle starts to move from the retracted position toward the extended position,
the opening is partially opened, and
the blind panel moves to the most forward position by the restoring force of the spring, thereby closing the partially opened opening.

8. The dish washer of claim 7, wherein when the blind panel has moved to the most forward position, the spring is in a state of being minimally compressed.

9. The dish washer of claim 7, wherein when the blind panel has moved to the most forward position, the blind panel is separated from the first handle body.

10. The dish washer of claim 7, wherein when the blind panel has moved to the most forward position, a front end surface of the blind panel stops while forming a continuous surface with a front surface of the door.

11. The dish washer of claim 7, wherein when the blind panel has moved to the most forward position, a front end surface of the blind panel stops at a position protruding from a front surface of the door.

12. The dish washer of claim 2, wherein the blind panel is connected to the bracket such that a spacing in a front-rear direction therebetween is variable.

13. The dish washer of claim 12, wherein the blind panel includes a first protrusion formed to protrude toward the bracket,
wherein the bracket includes a second protrusion formed to protrude toward the blind panel,
wherein the first protrusion and the second protrusion are connected to each other in a telescopic manner.

14. The dish washer of claim 2, further comprising a handle frame disposed inside the door and supporting the handle so as to be moveable.

15. The dish washer of claim 14, wherein an inner surface of the handle frame is integrally formed with multiple reinforcing ribs extending linearly along a front-rear direction,
wherein a back-and-forth horizontal movement of the blind panel is guided by the multiple reinforcing ribs.

16. The dish washer of claim 15, wherein the blind panel includes:
a panel body covering the opening; and
a flange formed to protrude along a vertical direction from an upper end surface or a lower end surface of the panel body,
wherein the flange has multiple slit, wherein the multiple reinforcing rib are inserted into the multiple slit.

17. A home appliance comprising:
a tub defining therein a washing space having an open front surface;
a door configured to open and close an inner surface defined inside the tub;
a handle configured to move back and forth between an extended position where the handle protrudes frontwards from the door and a retracted position where the handle is at least partially accommodated in the door;
a handle driver disposed inside the door and configured to move the handle from the retracted position toward the extended position or from the extended position toward the retracted position; and
a blind module configured to cover an opening defined through the door to allow the handle to pass therethrough when the handle has moved to the extended position,
wherein the blind module is configured to cover the opening while moving frontwards in association with a movement of the handle.
